(19) United States
(12) Patent Application Publication
(10) Pub. No.: US 2025/0097629 A1
(43) Pub. Date: Mar. 20, 2025

(54) ELECTROACOUSTIC TRANSDUCER

(71) Applicant: FUJIFILM Corporation, Tokyo (JP)

(72) Inventor: Tetsu MIYOSHI, Minamiashigara-shi (JP)

(73) Assignee: FUJIFILM Corporation, Tokyo (JP)

(21) Appl. No.: 18/967,164

(22) Filed: Dec. 3, 2024

Related U.S. Application Data
(63) Continuation of application No. PCT/JP2023/020327, filed on May 31, 2023.

(30) Foreign Application Priority Data
Jul. 8, 2022 (JP) 2022-110171
Feb. 10, 2023 (JP) 2023-018988

(51) Int. Cl. H04R 1/24; H04R 7/04; H04R 17/00

(52) U.S. Cl. CPC H04R 1/24; H04R 7/04; H04R 17/005; H04R 2499/15

(57) ABSTRACT

Provided is an electroacoustic transducer in which a decrease in sound pressure in a high sound band is suppressed and power consumption can be reduced, in an electroacoustic transducer in which a plurality of vibrators are arranged on a vibration plate. The electroacoustic transducer includes a vibration plate and a vibrator group consisting of a plurality of piezoelectric vibrators arranged on one surface of the vibration plate, in which the plurality of piezoelectric vibrators each belong to any one of a first group to an n-th group, an upper limit frequency of a frequency band of an input signal input to the piezoelectric vibrator is different for each group, and in a case where upper limit frequencies for each group are denoted by f₁ to fₙ, the upper limit frequencies gradually decrease from the upper limit frequency f₁ in the first group to the upper limit frequency fₙ in the n-th group.

### CROSS-REFERENCE TO RELATED APPLICATIONS

This application is a Continuation of PCT International Application No. PCT/JP2023/020327 filed on May 31, 2023, which claims priority under 35 U.S.C. § 119(a) to Japanese Patent Application No. 2022-110171 filed on Jul. 8, 2022 and Japanese Patent Application No. 2023-018988 filed on Feb. 10, 2023. The above applications are hereby expressly incorporated by reference, in their entirety, into the present application.

### BACKGROUND OF THE INVENTION

### 1. Field of the Invention

The present invention relates to an electroacoustic transducer.

### 2. Description of the Related Art

In a thin image display device such as a liquid crystal display and an organic EL display, in a case of being used as an image display device and a sound generation device which reproduces a voice together with an image, a speaker which is an acoustic device for generating the voice is required.

Here, examples of a typical shape of the speaker in the related art include a funnel-like so-called cone shape and a spherical dome shape. However, in a case where these speakers are incorporated in the above-described thin image display device, there is a concern that advantages of the thin image display device, such as thinness and lightness, may be impaired.

In such a thin image display device, a configuration in which an exciter (vibrator) is attached to a display panel and the display panel is vibrated as a vibration plate to reproduce a voice has been considered.

For example, JP2021-090167A discloses a display speaker including a display panel, a vibrator, and one or more vibration weights, in which the vibrator is surface-bonded to the display panel, and the vibration weight is bonded to the vibrator.

In addition, WO2020/095812A discloses, as a thin vibrator, a laminated piezoelectric element in which a plurality of layers of a piezoelectric film obtained by sandwiching a piezoelectric layer between two thin film electrodes are laminated, the piezoelectric film being polarized in a thickness direction and adjacent piezoelectric films having polarization directions opposite to each other. WO2020/095812A discloses an electroacoustic transducer which reproduces a voice by bonding the laminated piezoelectric element to a vibration plate.

### SUMMARY OF THE INVENTION

Since an output of the piezoelectric type vibrator (piezoelectric vibrator) disclosed in WO2020/095812A is relatively small, in a case where a large vibration plate such as a large-sized display panel is used, it is considered to secure the output by bonding a plurality of piezoelectric vibrators to the vibration plate and inputting the same signal to the plurality of piezoelectric vibrators.

However, according to the study by the present inventor, it is found that, in a case where a plurality of vibrators are arranged on a vibration plate to form an electroacoustic transducer, a sound pressure tends to decrease in a high sound band without increasing.

In addition, in a case where a plurality of vibrators are used, there is a problem that power consumption is high because it is necessary to supply power to each vibrator.

An object of the present invention is to solve the above-described problem of the related art, and to provide an electroacoustic transducer in which a decrease in sound pressure in a high sound band is suppressed and power consumption can be reduced, in an electroacoustic transducer in which a plurality of vibrators are arranged on a vibration plate.

In order to solve the above-described problems, the present invention has the following configuration.

[1] An electroacoustic transducer comprising:
a vibration plate; and
a vibrator group consisting of a plurality of piezoelectric vibrators arranged on one surface of the vibration plate,
in which the plurality of piezoelectric vibrators each belong to any one of a first group to an n-th group,
an upper limit frequency of a frequency band of an input signal input to the piezoelectric vibrator is different for each group, and
in a case where upper limit frequencies for each group are denoted by f₁ to fₙ, the upper limit frequencies gradually decrease from the upper limit frequency f₁ in the first group to the upper limit frequency fₙ in the n-th group.

[2] The electroacoustic transducer according to [1],
in which, in a case where the number of the piezoelectric vibrators belonging to each group is denoted by N₁ to Nₙ, the number of the piezoelectric vibrators in each group from the number N₁ of the piezoelectric vibrators in the first group to the number Nₙ of the piezoelectric vibrators in the n-th group satisfies N₁≤N₂≤N₃≤ . . . ≤Nₙ.

[3] The electroacoustic transducer according to [1] or [2],
in which the upper limit frequency f₁ in the first group is 15 kHz or more.

[4] The electroacoustic transducer according to any one of [1] to [3],
in which the electroacoustic transducer has two vibrator groups, and
the two vibrator groups are arranged symmetrically with respect to a center line of the vibration plate in a left-right direction.

[5] The electroacoustic transducer according to any one of [1] to [4],
in which the piezoelectric vibrator has a piezoelectric film which includes a piezoelectric layer and electrode layers provided on both surfaces of the piezoelectric layer.

[6] The electroacoustic transducer according to [5],
in which the piezoelectric layer consists of a polymer-based piezoelectric composite material containing piezoelectric particles in a matrix containing a polymer material.

[7] The electroacoustic transducer according to [5] or [6],
in which, in the piezoelectric vibrator, a plurality of layers of the piezoelectric film are laminated by folding the piezoelectric film one or more times.

[8] The electroacoustic transducer according to any one of [1] to [7],
in which outer peripheral edges of two adjacent piezoelectric vibrators are in a parallel relationship, and an interval between the outer peripheral edges is 40 mm or less.

[9] The electroacoustic transducer according to any one of [1] to [8],
in which the vibration plate is curved in an arrangement direction of the plurality of piezoelectric vibrators of the vibrator group.

[10] The electroacoustic transducer according to [9],
in which, in the arrangement direction of the plurality of piezoelectric vibrators, in a case where a distance from the piezoelectric vibrator on a center side of the vibration plate to a viewing position is denoted by L₁ and a distance from the piezoelectric vibrator on an outer side to the viewing position is denoted by L₂, a range of L₁×0.9<L₂<L₁×1.1 is satisfied.

[11] The electroacoustic transducer according to any one of [1] to [10],
in which, in an arrangement direction of the piezoelectric vibrators, in a case where a distance from the piezoelectric vibrator on a center side of the vibration plate to a viewing position is denoted by L₁ and a distance from the piezoelectric vibrator on an outer side to the viewing position is denoted by L₂, an input timing of the input signal to the piezoelectric vibrator on the outer side is set to be earlier than an input timing of the input signal to the piezoelectric vibrator on the center side by a time t=(L₂−L₁)/c,
where c (m/s) is a speed of sound.

According to the present invention, it is possible to provide an electroacoustic transducer in which a decrease in sound pressure in a high sound band is suppressed and power consumption can be reduced, in an electroacoustic transducer in which a plurality of vibrators are arranged on a vibration plate.

### BRIEF DESCRIPTION OF THE DRAWINGS

FIG. 1 is a view schematically showing an example of an electroacoustic transducer according to an embodiment of the present invention.

FIG. 2 is a block view showing an example of a circuit included in the electroacoustic transducer shown in FIG. 1.

FIG. 3 is a graph showing a relationship between a frequency and a standardized sound pressure, and a diagram showing a frequency band of each piezoelectric vibrator.

FIG. 4 is a graph showing a relationship between a frequency and a standardized sound pressure, and a diagram showing a frequency band of each piezoelectric vibrator.

FIG. 5 is a graph showing a relationship between an ideal sound pressure and a frequency in a configuration in which a plurality of piezoelectric vibrators are provided.

FIG. 6 is a graph showing a relationship between an actual sound pressure and a frequency in a configuration in which a plurality of piezoelectric vibrators are provided.

FIG. 7 is a diagram for describing power consumption of a piezoelectric vibrator.

FIG. 8 is a diagram for describing power consumption in a case where an upper limit frequency is 10 kHz.

FIG. 9 is a diagram for describing power consumption in a case where an upper limit frequency is 4 kHz.

FIG. 10 is a view for describing an example of a piezoelectric film of a piezoelectric vibrator included in the electroacoustic transducer according to the embodiment of the present invention.

FIG. 11 is a perspective view schematically showing the example of the piezoelectric vibrator included in the electroacoustic transducer according to the embodiment of the present invention.

FIG. 12 is a view schematically showing the example of the piezoelectric vibrator included in the electroacoustic transducer according to the embodiment of the present invention.

FIG. 13 is a view schematically showing another example of the piezoelectric vibrator included in the electroacoustic transducer according to the embodiment of the present invention.

FIG. 14 is a conceptual view for describing an example of a production method of the piezoelectric film.

FIG. 15 is a conceptual view for describing an example of a production method of the piezoelectric film.

FIG. 16 is a conceptual view for describing an example of a production method of the piezoelectric film.

FIG. 17 is a view schematically showing another example of the electroacoustic transducer according to the embodiment of the present invention.

FIG. 18 is a block view showing another example of a circuit included in the electroacoustic transducer according to the embodiment of the present invention.

FIG. 19 is a block view showing another example of a circuit included in the electroacoustic transducer according to the embodiment of the present invention.

FIG. 20 is a diagram for describing a difference in path.

FIG. 21 is a view schematically showing still another example of the electroacoustic transducer according to the embodiment of the present invention.

FIG. 22 is a view schematically showing still another example of the electroacoustic transducer according to the embodiment of the present invention.

### DESCRIPTION OF THE PREFERRED EMBODIMENTS

Hereinafter, the electroacoustic transducer according to the embodiment of the present invention will be described in detail based on suitable embodiments shown in the accompanying drawings.

Although configuration requirements to be described below are described based on representative embodiments of the present invention, the present invention is not limited to the embodiments.

Any numerical range expressed using “to” in the present specification refers to a range including the numerical values before and after the “to” as a lower limit value and an upper limit value, respectively.

In the present specification, terms “same”, “coincident”, and the like include an error range generally accepted in the technical field.

### First Embodiment

### [Electroacoustic Transducer]

The electroacoustic transducer according to the embodiment of the present invention includes a vibration plate and a vibrator group consisting of a plurality of piezoelectric vibrators arranged on one surface of the vibration plate, in which the plurality of piezoelectric vibrators each belong to any one of a first group to an n-th group, an upper limit frequency of a frequency band of an input signal input to the piezoelectric vibrator is different for each group, and in a case where upper limit frequencies for each group are denoted by f₁ to fₙ, the upper limit frequencies gradually decrease from the upper limit frequency f₁ in the first group to the upper limit frequency fₙ in the n-th group.

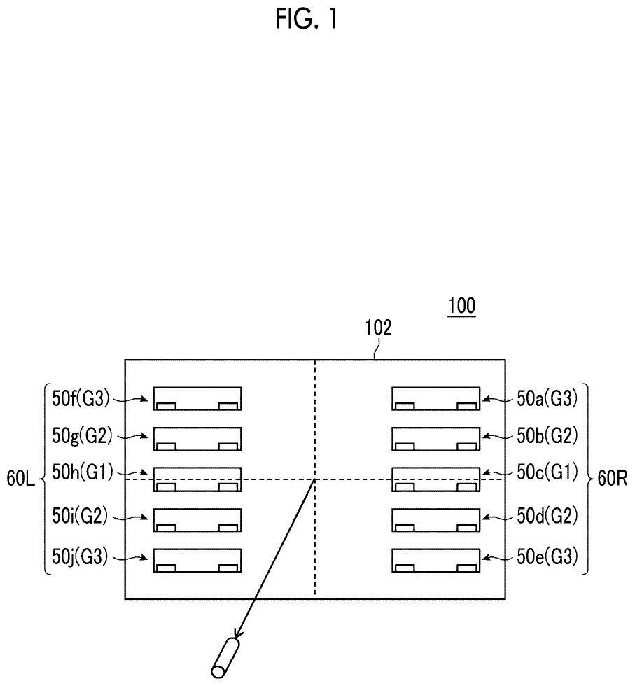

FIG. 1 shows a view schematically showing an example of the electroacoustic transducer according to the embodiment of the present invention.

An electroacoustic transducer 100 shown in FIG. 1 includes a vibration plate 102 and a plurality of piezoelectric vibrators (50a to 50j) disposed on one surface of the vibration plate 102.

The piezoelectric vibrators (50a to 50j) are driven by applying a voltage using an external power supply. In a case where the piezoelectric vibrator is driven, the piezoelectric vibrator stretches and contracts in a plane direction, and the piezoelectric vibrator bends the vibration plate to which the piezoelectric vibrator is bonded, and as a result, the vibration plate is vibrated to generate a sound. The vibration plate vibrates according to a magnitude of a driving voltage applied to the piezoelectric vibrator and generates the sound according to the driving voltage applied to the piezoelectric vibrator.

That is, the piezoelectric vibrator functions as a so-called exciter.

In the example shown in FIG. 1, five piezoelectric vibrators 50a to 50e are arranged in a right-side region in a left-right direction of the vibration plate 102 in the drawing. The five piezoelectric vibrators 50a to 50e are arranged in an up-down direction in the drawing. The five piezoelectric vibrators 50a to 50e are a vibrator group 60R in the present invention, and basically the same signals are input to the piezoelectric vibrators 50a to 50e included in one vibrator group 60R except that high-sound band vibration is appropriately cut.

In addition, five piezoelectric vibrators 50f to 50j are arranged in a left-side region in the left-right direction of the vibration plate 102 in the drawing. The five piezoelectric vibrators 50f to 50j are arranged in the up-down direction in the drawing. The five piezoelectric vibrators 50f to 50j are a vibrator group 60L in the present invention, and basically the same signals are input to the piezoelectric vibrators 50f to 50j included in one vibrator group 60L except that high-sound band vibration is appropriately cut.

That is, the electroacoustic transducer 100 shown in FIG. 1 has two vibrator groups, and the two vibrator groups are symmetrically with respect to a center line of the vibration plate 102 in the left-right direction.

The signals input to the piezoelectric vibrators 50a to 50e of the vibrator group 60R and the signals input to the piezoelectric vibrators 50f to 50j of the vibrator group 60L may be the same or different from each other. For example, a signal of a right channel of a stereo audio is input to the piezoelectric vibrators 50a to 50e of the vibrator group 60R, and a signal of a left channel is input to the piezoelectric vibrators 50f to 50j of the vibrator group 60L.

The vibrator group 60R and the vibrator group 60L basically have the same configuration, except that arrangement positions and input signals are different. Therefore, in the following description, the vibrator group 60R will be described.

In addition, the configurations of the piezoelectric vibrators may be the same or different from each other. The piezoelectric vibrator will be described in detail later.

In the electroacoustic transducer 100 shown in FIG. 1, a plurality of piezoelectric vibrators of the vibrator group 60R belong to any one of three groups of a first group to a third group. In the example shown in FIG. 1, the piezoelectric vibrator 50c disposed at a center in an up-down direction in the drawing belongs to a first group G1; the piezoelectric vibrator 50b disposed on an upper side of the piezoelectric vibrator 50c and the piezoelectric vibrator 50d disposed on a lower side of the piezoelectric vibrator 50c belong to a second group G2; and the piezoelectric vibrator 50a disposed on an upper side of the piezoelectric vibrator 50b and the piezoelectric vibrator 50e disposed on a lower side of the piezoelectric vibrator 50d belong to a third group G3.

An input signal having an upper limit frequency of a frequency band different for each group is input to each piezoelectric vibrator.

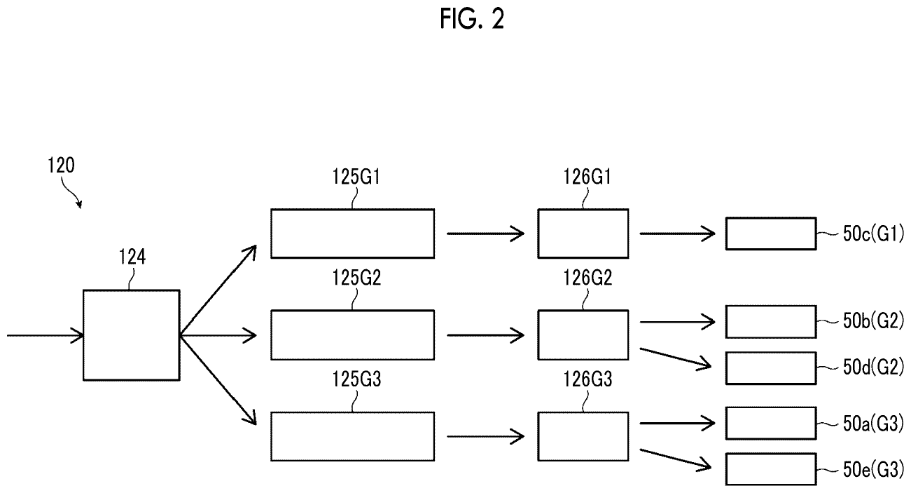

FIG. 2 is a view schematically showing a block diagram of a circuit for inputting the input signal to each piezoelectric vibrator of the electroacoustic transducer 100.

A circuit 120 shown in FIG. 2 includes a distributor 124 for distributing an input signal input from the outside to each group, three low-pass filters 125G1 to 125G3 which perform filter processing on the distributed signals, three amplifiers 126G1 to 126G3, and piezoelectric vibrators 50a to 50e.

In the circuit shown in FIG. 2, the input signal input from the outside is input to the piezoelectric vibrator through the distributor and then through the amplifier.

The distributor 124 performs processing of distributing the input signal from the outside. In the illustrated example, since the piezoelectric vibrators 50a to 50e are divided into the three groups, the distributor 124 distributes the input signal from the outside into three signals.

Here, in the present invention, the three low-pass filters 125G1 to 125G3 are provided in a rear stage of the distributor 124 such that upper limit frequencies of frequency bands of the input signals input to the piezoelectric vibrators 50a to 50e, divided into three groups, are different for each group, and each of the low-pass filter processing is performed.

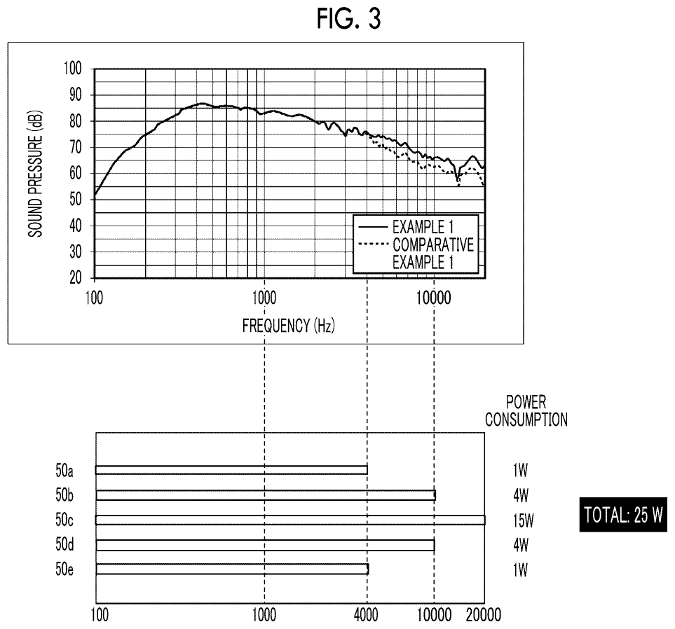

For example, as shown in the lower part of FIG. 3, in a case where an input signal having an upper limit frequency f₁ of 20 kHz is input to the piezoelectric vibrator 50c belonging to the first group G1, an input signal having an upper limit frequency f₂ of 10 kHz is input to the piezoelectric vibrators 50b and 50d belonging to the second group G2, and an input signal having an upper limit frequency f₃ of 4 kHz is input to the piezoelectric vibrators 50a and 50e belonging to the third group G3, the low-pass filter 125G1 performs low-pass filter processing on the distributed input signal such that the upper limit frequency f₁ is set to 20 kHz. As a result, the input signal having the upper limit frequency f₁ of 20 kHz is distributed to the piezoelectric vibrator 50c belonging to the first group G1. The low-pass filter 125G2 performs low-pass filter processing on the distributed input signal such that the upper limit frequency f₂ is set to 10 kHz. As a result, the input signal having the upper limit frequency f₂ of 10 kHz is distributed to the piezoelectric vibrators 50b and 50d belonging to the second group G2. The low-pass filter 125G3 performs low-pass filter processing on the distributed input signal such that the upper limit frequency f₃ is set to 4 kHz. As a result, the input signal having the upper limit frequency f₃ of 4 kHz is distributed to the piezoelectric vibrators 50a and 50e belonging to the third group G3.

That is, in a case where the upper limit frequencies in each group are denoted by f₁ to f₃, the upper limit frequencies gradually decreases from the upper limit frequency f₁ in the first group to the upper limit frequency f₃ in the third group.

Each of the input signals branched and subjected to the low-pass filter processing by the distributor 124 and each low-pass filter, having different upper limit frequencies, is amplified by the amplifiers 126G1 to 126G3 and is supplied to each piezoelectric vibrator.

In the example shown in FIG. 2, an input signal amplified by the amplifier 126G1 is supplied to the piezoelectric vibrator 50c belonging to the first group G1. In addition, an input signal amplified by the amplifier 126G2 is supplied to the piezoelectric vibrator 50b and the piezoelectric vibrator 50d belonging to the second group G2. In addition, an input signal amplified by the amplifier 126G3 is supplied to the piezoelectric vibrator 50a and the piezoelectric vibrator 50e belonging to the third group G3.

As the amplifiers 126G1 to 126G3, various known amplifiers used in the electroacoustic transducer can be appropriately used.

Each piezoelectric vibrator is driven by inputting the input signal amplified by each amplifier. In a case where each piezoelectric vibrator is driven, the piezoelectric vibrator stretches and contracts in a plane direction, and the piezoelectric vibrator bends the vibration plate to which the piezoelectric vibrator is bonded, and as a result, the vibration plate is vibrated to generate a sound.

In this case, in the electroacoustic transducer according to the embodiment of the present invention, by inputting input signals having different upper limit frequencies for each group, a decrease in sound pressure in a high sound band can be suppressed, and power consumption can be reduced.

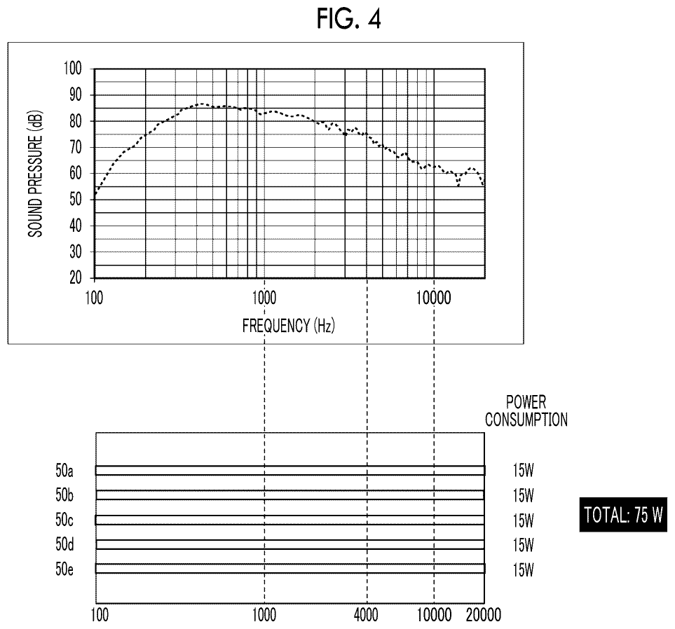

This point will be described with reference to FIGS. 3 and 4 which are results of Examples and Comparative Examples described later.

In FIGS. 3 and 4, upper graphs are graphs showing a relationship between a frequency and a standardized sound pressure, and lower parts are diagrams showing frequency bands of input signals input to each piezoelectric vibrator.

As shown in the lower part, FIG. 4 is an example of the related art, in which input signals having the same upper limit frequency are input to all the piezoelectric vibrators, and the graph in the upper part shows frequency characteristics (a relationship between the frequency and the sound pressure) in this case.

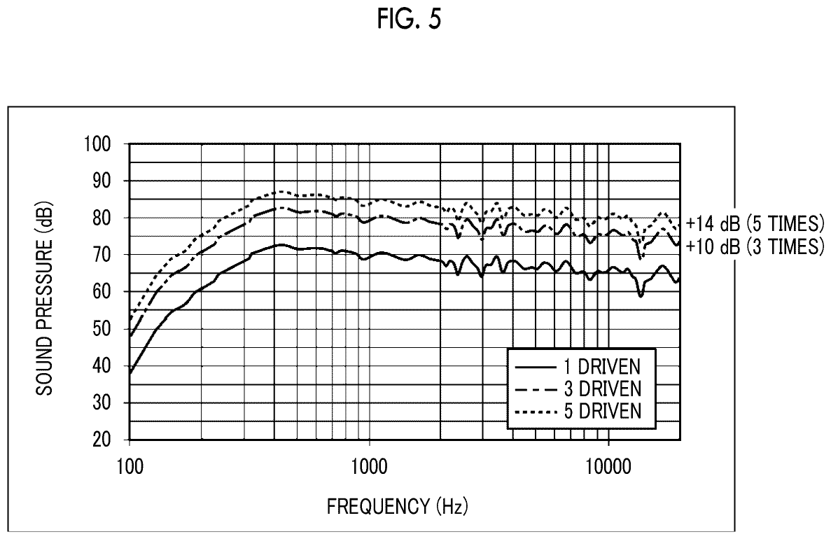

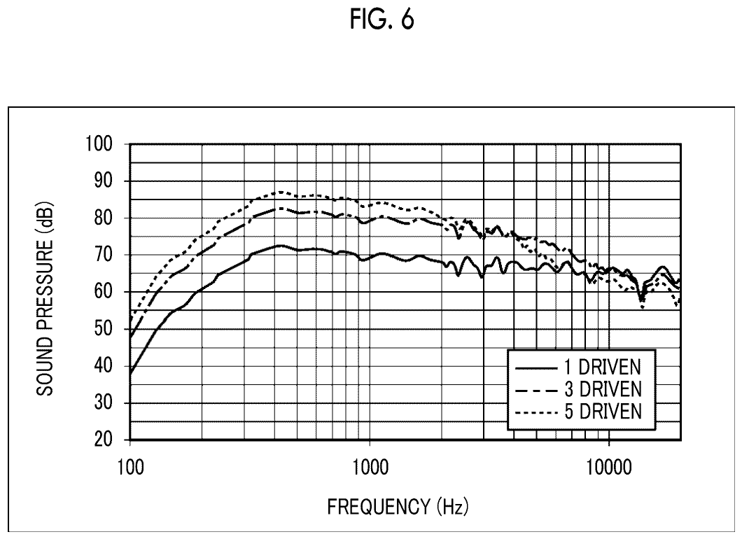

In addition, FIG. 5 shows a graph showing ideal (no phase interference) frequency characteristics in a case where three or five piezoelectric vibrators are driven based on the actually measured value of frequency characteristics in which one piezoelectric vibrator is driven; and FIG. 6 shows a graph showing frequency characteristics in a case where one, three, or five piezoelectric vibrators are actually driven.

As shown in FIG. 5, in an ideal case in which there is no phase interference, a sound pressure in a case where three piezoelectric vibrators are driven is approximately three times (+10 dB) a sound pressure in a case where one piezoelectric vibrator is driven, in a wide frequency range of 100 to 20 kHz. In addition, a sound pressure in a case where five piezoelectric vibrators are driven is approximately five times (+14 dB) the sound pressure in a case where one piezoelectric vibrator is driven, in a wide frequency range of 100 to 20 kHz.

However, in reality, since the phase interference occurs, as shown in FIG. 6, the sound pressure may not be improved and may be conversely decreased in a high frequency band even in a case where the number of piezoelectric vibrators is increased.

As shown in FIG. 6, in a frequency band of 4 kHz or less, the sound pressure is improved as the number of piezoelectric vibrators is increased. However, in a band in which the frequency exceeds 4 kHz, the sound pressure may not be improved and may be conversely decreased even in a case where the number of piezoelectric vibrators is increased.

Therefore, as shown in the upper graph of FIG. 4, in a case where the input signals having the same upper limit frequency are input to all of the five piezoelectric vibrators, the sound pressure is significantly low in a high frequency band.

As described above, in a case where the electroacoustic transducer is configured such that the plurality of piezoelectric vibrators are arranged on the vibration plate, the cause of the fact that the sound pressure is not improved and is conversely decreased in a high sound band is considered to be the phase interference. In the above-described electroacoustic transducer, since the vibration plate vibrates in the region where each piezoelectric vibrator is disposed to generate a sound, there is a difference in path length for each piezoelectric vibrator at a certain viewing position. Therefore, a phenomenon in which the sound pressure is not improved occurs due to the phase interference between a positive phase component and a negative phase component, that is, due to cancellation of sound waves due to the difference in path.

In this case, in a low frequency band, since the wavelength of the sound wave is long, the cancellation is unlikely to occur even in a case where there is a small difference in path, the sound pressure does not decrease, and the sound pressure is improved by the addition effect.

On the other hand, in a high sound band, since the wavelength of the sound wave is short, the cancellation occurs due to a small difference in path, and as a result, not only the addition effect does not function and the sound pressure does not increase, but also the sound pressure may be lowered for a plurality of piezoelectric vibrators with respect to one piezoelectric vibrator. The reason why the sound pressure is lowered for the plurality of piezoelectric vibrators includes a ratio of individuals which deliver a positive phase component to the viewing position and individuals which deliver a negative phase component to the viewing position, a variation in performance of each individual, and the like.

In addition, in a case where each piezoelectric vibrator is driven by an input signal in the same frequency band, since the power consumption of each piezoelectric vibrator is the same, the total power consumption of the vibrator group is a multiple (five times in the illustrated example) of the power consumption of one piezoelectric vibrator. For example, in a case where the power consumption of one piezoelectric vibrator is 15 W, the total power consumption of the vibrator group is 75 W.

On the other hand, in the electroacoustic transducer according to the embodiment of the present invention, input signals having different upper limit frequencies are input for each group. This point will be described with reference to FIGS. 3 and 6.

From FIG. 6, in a frequency band of 10 kHz to 20 kHz, the sound pressure is highest in a case where one piezoelectric vibrator is driven. Therefore, as shown in the lower part of FIG. 3, one piezoelectric vibrator 50c belongs to the first group G1, and an input signal in a frequency band having an upper limit frequency of 20 kHz or more is input to the piezoelectric vibrator 50c.

Next, from FIG. 6, in a frequency band of 4 kHz to 10 kHz, the sound pressure is highest in a case where three piezoelectric vibrators are driven. Therefore, as shown in the lower part of FIG. 3, an input signal having a frequency band of 10 kHz or less is input to three piezoelectric vibrators including the piezoelectric vibrator 50c belonging to the first group and the two piezoelectric vibrators 50b and 50d belonging to the second group G2.

Next, from FIG. 6, in a frequency band of 4 kHz or less, the sound pressure is highest in a case where five piezoelectric vibrators are driven. Therefore, as shown in the lower part of FIG. 3, an input signal having a frequency band of 4 kHz or less is input to five piezoelectric vibrators including the piezoelectric vibrator 50c belonging to the first group, the piezoelectric vibrators 50b and 50d belonging to the second group G2, and the two piezoelectric vibrators 50a and 50e belong to the third group G3.

As described above, in each frequency band, by making the upper limit frequencies of the input signals input to the piezoelectric vibrators of each group different such that the number of driven piezoelectric vibrators is the number at which the sound pressure is highest, it is possible to suppress a significant decrease in sound pressure in the high frequency band.

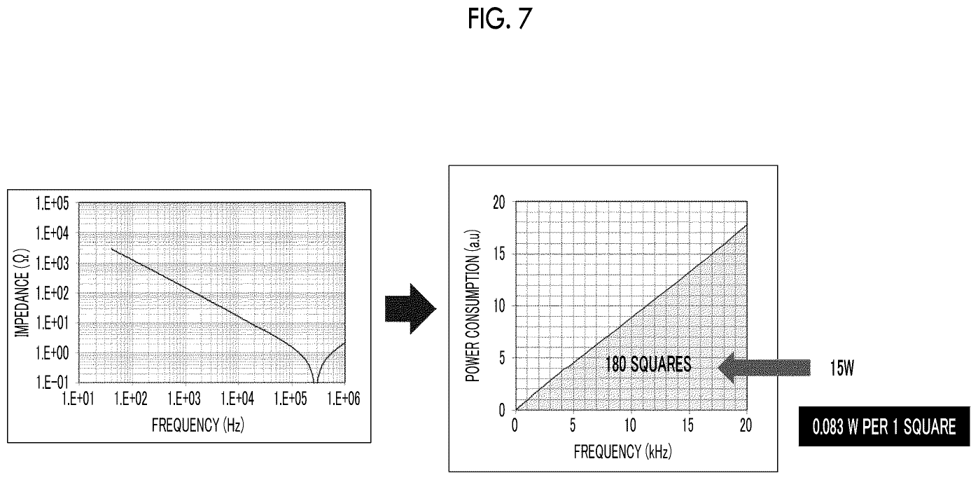

Furthermore, as shown on the right side of the lower part of FIG. 3, by making the upper limit frequencies of the input signals input to the piezoelectric vibrators of each group different, the power consumption of the piezoelectric vibrators of the second and third groups can be made lower than the power consumption of the piezoelectric vibrators of the first group. This point will be described with reference to FIGS. 7 to 9.

The graph on the left side of FIG. 7 is a graph schematically showing a relationship between a frequency and an impedance in the piezoelectric vibrator. As shown in the drawing, impedance characteristics of the piezoelectric vibrator are lower as the frequency is higher in a band up to 20 kHz. In a case where the power consumption of the piezoelectric vibrator having such impedance characteristics is standardized, as 1, for each frequency with the power consumption in a case where a sine wave of 1 kHz is input while the voltage is constant, the power consumption increases as the frequency increases as shown in the graph schematically shown on the right side of FIG. 7. For example, in a case where an input signal of 0 to 20 kHz is input to the piezoelectric vibrator, a value obtained by integrating the right graph of FIG. 7 (area of a region shown in gray in the drawing) is the power consumption of the piezoelectric vibrator. In a case where one square is a standardized power consumption of 1 at a frequency of 1 kHz, the area portion is approximately 180 squares.

As an example, in a case where a voltage is applied such that the power consumption is 15 W in which an input signal of 0 to 20 kHz is input to the piezoelectric vibrator, the power consumption per one square is 0.083 W.

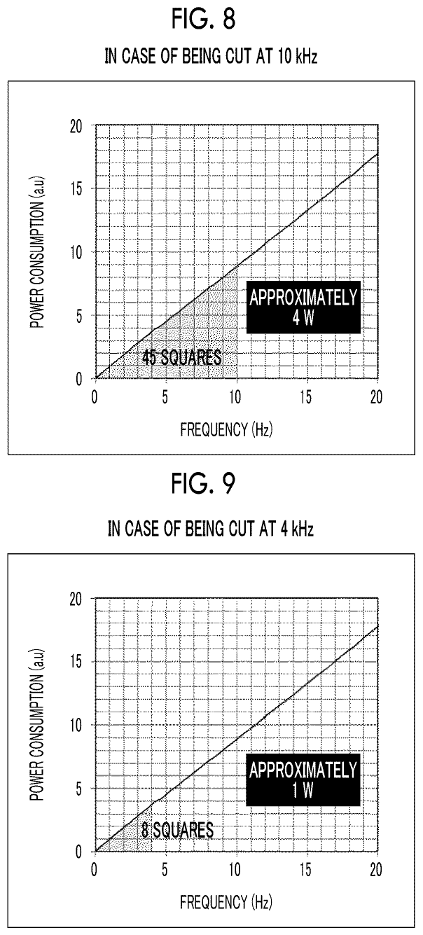

Since an input signal having an upper limit frequency of 10 kHz is input to the piezoelectric vibrators of the second group G2, the power consumption thereof is approximately 4 W for 45 squares as shown in FIG. 8.

Since an input signal having an upper limit frequency of 4 kHz is input to the piezoelectric vibrators of the third group G3, the power consumption thereof is approximately 1 W for 8 squares as shown in FIG. 9.

Therefore, the total power consumption of the vibrator group 60R is 15 W+4 W×2+1 W×2=25 W.

In this way, the power consumption of the piezoelectric vibrator in which the upper limit frequency of the input signal is lowered can be significantly reduced. Therefore, it is possible to significantly reduce the power consumption of the vibrator group.

Here, in the above-described example, the configuration in which one vibrator group includes five piezoelectric vibrators is adopted, but the present invention is not limited thereto. One vibrator group may include two to four piezoelectric vibrators or may include six or more piezoelectric vibrators.

In addition, in the above-described example, the plurality of piezoelectric vibrators are divided into three groups, but the present invention is not limited thereto; and the plurality of piezoelectric vibrators may be divided into two groups or may be divided into four or more groups. In a case where the plurality of piezoelectric vibrators are divided into n groups, and upper limit frequencies in the first group to the n-th group are denoted by f₁ to fₙ, the upper limit frequency gradually decreases from the upper limit frequency f₁ in the first group to the upper limit frequency fₙ in the n-th group.

Furthermore, in the above-described example, the upper limit frequency of the input signal input to the piezoelectric vibrator of the first group G1 is set to 20 kHz, the upper limit frequency of the input signal input to the piezoelectric vibrator of the second group G2 is set to 10 kHz, and the upper limit frequency of the input signal input to the piezoelectric vibrator of the third group G3 is set to 4 kHz, but the present invention is not limited thereto. The upper limit frequency of the input signal input to each group may be appropriately set according to the configuration of the electroacoustic transducer, the characteristics of the piezoelectric vibrator, the required specifications of the product, and the like.

The upper limit frequency of the input signal input to the piezoelectric vibrator belonging to the first group having the highest upper limit frequency is preferably 15 kHz or more, from the viewpoint of practical audible range.

In addition, the number of piezoelectric vibrators belonging to each group is not particularly limited, but it is preferable to decrease the number of piezoelectric vibrators as the upper limit frequency of the group is higher. That is, in a case where the number of the piezoelectric vibrators belonging to the first group to the n-th group is denoted by N₁ to Nₙ, it is preferable that the number of the piezoelectric vibrators in each group from the number N₁ of the piezoelectric vibrators in the first group to the number Nₙ of the piezoelectric vibrators in the n-th group satisfies N₁≤N₂≤N₃≤ . . . ≤Nₙ. By decreasing the number of piezoelectric vibrators in a group having a higher upper limit frequency, the decrease in sound pressure due to the phase interference in the high frequency band can be more suitably suppressed, and the power consumption can be more suitably reduced.

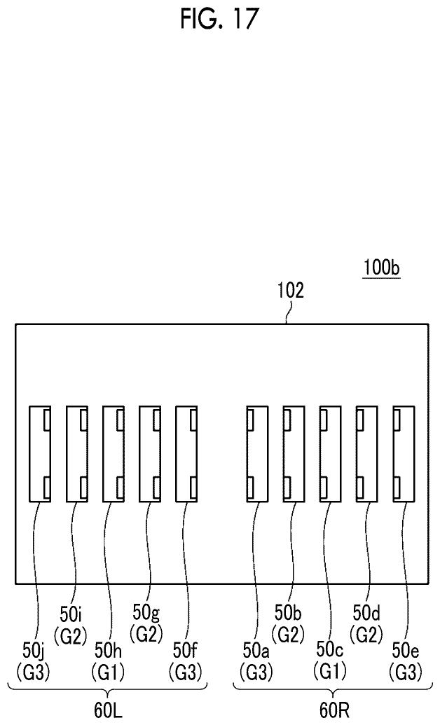

In addition, in the example shown in FIG. 1, the plurality of piezoelectric vibrators in one vibrator group are arranged in the up-down direction, but the present invention is not limited thereto. For example, as shown in FIG. 17, the plurality of piezoelectric vibrators may be arranged in the left-right direction or may be two-dimensionally arranged in the up-down direction and the left-right direction.

In the example shown in FIG. 17, five piezoelectric vibrators 50a to 50e are arranged in a right-side region in the left-right direction of the vibration plate 102 in the drawing. The five piezoelectric vibrators 50a to 50e are arranged in the left-right direction in the drawing. The five piezoelectric vibrators 50a to 50e are the vibrator group 60R in the present invention, and basically the same signals are input to the piezoelectric vibrators 50a to 50e included in one vibrator group 60R except that high-sound band vibration is appropriately cut.

In addition, five piezoelectric vibrators 50f to 50j are arranged in a left-side region in the left-right direction of the vibration plate 102 in the drawing. The five piezoelectric vibrators 50f to 50j are arranged in the left-right direction in the drawing. The five piezoelectric vibrators 50f to 50j are the vibrator group 60L in the present invention, and basically the same signals are input to the piezoelectric vibrators 50f to 50j included in one vibrator group 60L except that high-sound band vibration is appropriately cut.

That is, an electroacoustic transducer 100b shown in FIG. 17 has two vibrator groups, and the two vibrator groups are symmetrically with respect to a center line of the vibration plate 102 in the left-right direction.

Signals input to the piezoelectric vibrators 50a to 50e of the vibrator group 60R and signals input to the piezoelectric vibrators 50f to 50j of the vibrator group 60L may be the same or different from each other. For example, a signal of a right channel of a stereo audio is input to the piezoelectric vibrators 50a to 50e of the vibrator group 60R, and a signal of a left channel is input to the piezoelectric vibrators 50f to 50j of the vibrator group 60L.

Even in the electroacoustic transducer 100b shown in FIG. 17, as in the example shown in FIG. 1, an input signal having an upper limit frequency of a frequency band different for each group is input to each piezoelectric vibrator of the vibrator group.

In addition, it is preferable that, in one vibrator group, outer peripheral edges of two piezoelectric vibrators arranged adjacent to each other are in a parallel relationship.

In addition, an interval between the adjacent piezoelectric vibrators is not particularly limited, but as the interval between the piezoelectric vibrators is smaller, the difference in path is smaller, so that, from the viewpoint of suppressing the phase interference, it is preferable to bring the piezoelectric vibrators as close as possible; and the interval is preferably 40 mm or less, more preferably 20 mm or less, still more preferably 10 mm or less, and particularly preferably 5 mm or less. In a case where the interval between the adjacent piezoelectric vibrators is reduced, the frequency at which the phase interference occurs is moved to the high band side, so that the upper limit frequency of the input signal input to the piezoelectric vibrators of each group may be appropriately adjusted.

On the other hand, depending on a material of the vibration plate, crosstalk and the like may occur in a case where the piezoelectric vibrators are brought too close to each other, so that it is preferable to bring the piezoelectric vibrators as close to each other as possible according to the material of the vibration plate.

In addition, the electroacoustic transducer 100 shown in FIG. 1 has a configuration in which two vibrator groups are provided, but the present invention is not limited thereto. The electroacoustic transducer according to the embodiment of the present invention may have a configuration in which one vibrator group is provided, or may have a configuration in which three or more vibrator groups are provided.

In addition, in the electroacoustic transducer 100 shown in FIG. 1, the two vibrator groups are arranged symmetrically with respect to the center line of the vibration plate in the left-right direction, but the present invention is not limited thereto; and the disposition of each vibrator group may be appropriately set according to the performance required for the electroacoustic transducer and the like. The up-down direction and the left-right direction of the vibration plate (electroacoustic transducer) may be determined such that a vertical direction is the up-down direction and a horizontal direction is the left-right direction in a state in which the electroacoustic transducer is installed for use. In addition, in a case where the vibration plate is an image display panel, the up-down direction and the left-right direction may be set in accordance with a video displayed by the image display panel.

In addition, in the example of the circuit shown in FIG. 2, the low-pass filter for changing the upper limit frequency of the input signal corresponding to each group is provided after the distribution by the distributor, but the present invention is not limited thereto; and instead of the distributor, a channel divider, a digital signal processor (DSP), or the like can also be used for achieving the same effect. In addition, the distribution of the input signal and the low-pass filter processing may be performed by one channel divider, DSP, or the like.

In addition, in a case where the input signal is a digital audio signal, a digital signal may be distributed as it is, subjected to the low-pass filter processing, and then subjected to D-A conversion to be converted into an analog signal, and the analog signal may be put into the amplifier; or the digital signal may be subjected to D-A conversion to be converted into an analog signal, distributed, subjected to the low-pass filter processing by an analog low-pass filter, and then may be put into the amplifier.

In addition, in the example of the circuit shown in FIG. 2, the configuration in which the amplification by the amplifier is performed for each group after the distribution by the distributor is adopted, but the present invention is not limited thereto.

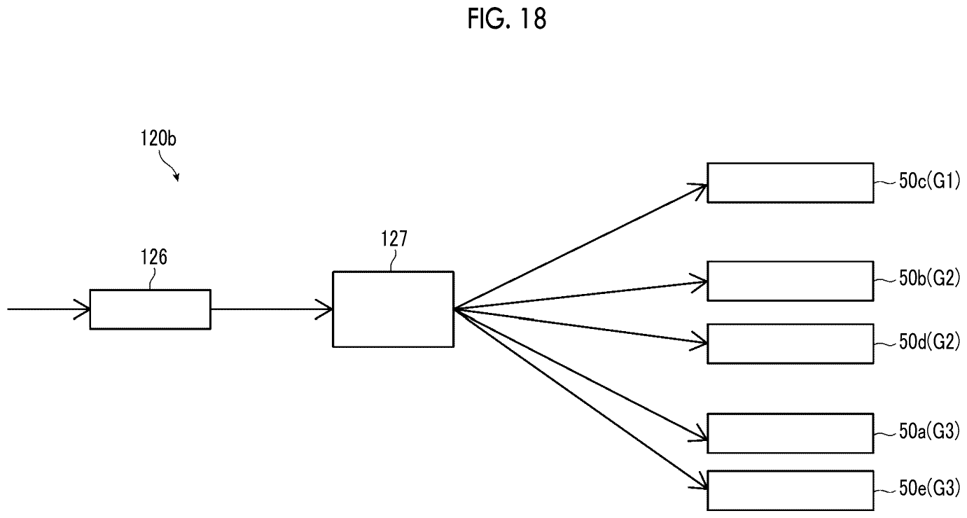

FIG. 18 shows a block view showing another example of a circuit included in the electroacoustic transducer according to the embodiment of the present invention.

A circuit 120b shown in FIG. 18 includes one amplifier 126 which amplifies an input signal input from the outside, a channel divider 127 which distributes the amplified signal to each group and performs filter processing for each group, and piezoelectric vibrators 50a to 50e.

In the circuit shown in FIG. 18, the input signal input from the outside is input to the piezoelectric vibrator through the amplifier 126 and then through the channel divider 127.

The channel divider 127 performs processing of distributing the input signal amplified by the amplifier 126. In the illustrated example, since the piezoelectric vibrators 50a to 50e are divided into the three groups, the channel divider 127 distributes the input signal into three signals.

In addition, the channel divider 127 performs low-pass filter processing having different cutoff frequencies on the three input signals to be distributed, and supplies input signals having upper limit frequencies different from each other to the piezoelectric vibrators 50a to 50e divided into three groups.

For example, same as in the example shown in the lower part of FIG. 3, in a case where an input signal having an upper limit frequency f₁ of 20 kHz is input to the piezoelectric vibrator 50c belonging to the first group G1, an input signal having an upper limit frequency f₂ of 10 kHz is input to the piezoelectric vibrators 50b and 50d belonging to the second group G2, and an input signal having an upper limit frequency f₃ of 4 kHz is input to the piezoelectric vibrators 50a and 50e belonging to the third group G3; and the channel divider 127 performs low-pass filter processing on an input signal supplied to the piezoelectric vibrator 50c belonging to the first group G1 among the distributed input signals such that a cutoff frequency fc₁ is set to 20 kHz. In addition, the channel divider 127 performs low-pass filter processing on an input signal supplied to the piezoelectric vibrators 50b and 50d belonging to the second group G2 among the distributed input signals such that a cutoff frequency fc₂ is set to 10 kHz. In addition, the channel divider 127 performs low-pass filter processing on an input signal supplied to the piezoelectric vibrators 50a and 50e belonging to the third group G3 among the distributed input signals such that a cutoff frequency fc₃ is set to 4 kHz.

Each input signal distributed by the channel divider 127 and subjected to the low-pass filter processing, having a different upper limit frequency, is supplied to each piezoelectric vibrator.

Each piezoelectric vibrator is driven by inputting input signals having different upper limit frequencies. In a case where each piezoelectric vibrator is driven, the piezoelectric vibrator stretches and contracts in a plane direction, and the piezoelectric vibrator bends the vibration plate to which the piezoelectric vibrator is bonded, and as a result, the vibration plate is vibrated to generate a sound.

In this case, in the electroacoustic transducer according to the embodiment of the present invention, by inputting input signals having different upper limit frequencies for each group, a decrease in sound pressure in a high sound band can be suppressed, and power consumption can be reduced.

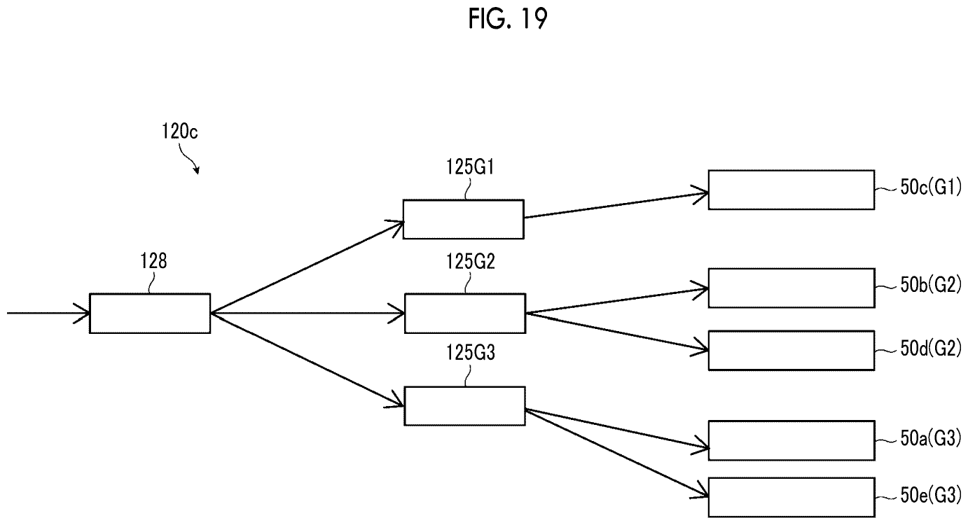

FIG. 19 shows a block view showing still another example of a circuit included in the electroacoustic transducer according to the embodiment of the present invention.

A circuit 120c shown in FIG. 19 includes one amplifier 128 having a function as a distributor which amplifies an input signal input from the outside and distributes the input signal to each group, low-pass filters 125G1 to 125G3 which perform filter processing on the distributed signals, and piezoelectric vibrators 50a to 50e.

In the circuit shown in FIG. 19, the input signal input from the outside is input to the piezoelectric vibrator after passing through the amplifier 128 and then passing through the low-pass filters 125G1 to 125G3.

The amplifier 128 amplifies the input signal input from the outside and performs processing of distributing the amplified input signal. In the illustrated example, since the piezoelectric vibrators 50a to 50e are divided into the three groups, the amplifier 128 distributes the input signal into three signals.

The input signals divided into three signals are supplied to the low-pass filters 125G1 to 125G3, respectively.

The low-pass filters 125G1 to 125G3 perform low-pass filter processing in which cutoff frequencies are different from each other.

For example, same as in the example shown in the lower part of FIG. 3, in a case where an input signal having an upper limit frequency f₁ of 20 kHz is input to the piezoelectric vibrator 50c belonging to the first group G1, an input signal having an upper limit frequency f₂ of 10 kHz is input to the piezoelectric vibrators 50b and 50d belonging to the second group G2, and an input signal having an upper limit frequency f₃ of 4 kHz is input to the piezoelectric vibrators 50a and 50e belonging to the third group G3; and the low-pass filter 125G1 performs low-pass filter processing on an input signal supplied to the piezoelectric vibrator 50c belonging to the first group G1 among the amplified and distributed input signals such that a cutoff frequency fc₁ is set to 20 kHz. In addition, the low-pass filter 125G2 performs low-pass filter processing on an input signal supplied to the piezoelectric vibrators 50b and 50d belonging to the second group G2 among the distributed input signals such that a cutoff frequency fc₂ is set to 10 kHz. In addition, the low-pass filter 125G3 performs low-pass filter processing on an input signal supplied to the piezoelectric vibrators 50a and 50e belonging to the third group G3 among the distributed input signals such that a cutoff frequency fc₃ is set to 4 kHz.

Each input signal subjected to the low-pass filter processing by the low-pass filters 125G1 to 125G3, having a different upper limit frequency, is supplied to each piezoelectric vibrator.

Each piezoelectric vibrator is driven by inputting input signals having different upper limit frequencies. In a case where each piezoelectric vibrator is driven, the piezoelectric vibrator stretches and contracts in a plane direction, and the piezoelectric vibrator bends the vibration plate to which the piezoelectric vibrator is bonded, and as a result, the vibration plate is vibrated to generate a sound.

In this case, in the electroacoustic transducer according to the embodiment of the present invention, by inputting input signals having different upper limit frequencies for each group, a decrease in sound pressure in a high sound band can be suppressed, and power consumption can be reduced.

As in the example shown in FIG. 1, in a case of a configuration in which two vibrator groups are provided, a signal of a right channel of a stereo audio is input to one vibrator group, and a signal of a left channel is input to the other vibrator group, the amplifier 126 included in the circuit 120b shown in FIG. 18 and the amplifier 128 included in the circuit 120c shown in FIG. 19 may be a stereo amplifier which amplifies the signals of the right channel and the left channel included in the stereo audio (signal), respectively.

In addition, the amplifier 128 included in the circuit 120c shown in FIG. 19 may be a stereo amplifier which amplifies the signals of the right channel and the left channel included in the stereo audio (signal), respectively, and may be configured to distribute the signal of the right channel to a plurality of groups and distribute the signal of the left channel to a plurality of groups, according to the number of groups.

Alternatively, in the example shown in FIG. 18, the channel divider 127 may distribute the stereo audio (signal) to each group, perform filter processing for each group, and then distribute the audio to the right channel and the left channel. Similarly, in the example shown in FIG. 19, a configuration in which the low-pass filters 125G1 to 125G3 perform filtering processing on the stereo audio (signal) and then distribute the audio to the right channel and the left channel may be adopted.

In addition, as in the examples shown in FIGS. 18 and 19, the configuration in which the amplifier is provided on the upstream side of the distributor (a portion having the distribution function) is advantageous from the viewpoint of cost reduction because the number of amplifiers can be reduced, as compared with the configuration in which the amplifier is provided on the downstream side of the distributor (a portion having the distribution function) as in the example shown in FIG. 2. This point is the same even in a configuration in which the upper limit frequencies of the input signals input to the plurality of piezoelectric vibrators included in one vibrator group are not different from each other.

Hereinafter, constituent elements of the electroacoustic transducer according to the embodiment of the present invention will be described.

### <Vibration Plate>

As a preferred aspect, the vibration plate 102 has flexibility. In the present invention, the expression of “having flexibility” is synonymous with having flexibility in the general interpretation, and indicates being capable of bending and being flexible, specifically, being capable of bending and stretching without causing breakage and damage.

The vibration plate 102 is not limited as long as the vibration plate preferably has flexibility, and various sheet-like materials (plate-like material and film) can be used.

Examples thereof include resin films made of polyethylene terephthalate (PET), polypropylene (PP), polystyrene (PS), polycarbonate (PC), polyphenylene sulfide (PPS), polymethylmethacrylate (PMMA), polyetherimide (PEI), polyimide (PI), polyethylene naphthalate (PEN), triacetyl cellulose (TAC), cyclic olefin-based resins, or the like; foamed plastics made of expanded polystyrene, expanded styrene, expanded polyethylene, or the like; veneer boards; cork boards; leathers such as cowhide; various kinds of paperboards such as carbon sheets and Japanese paper; and various kinds of corrugated cardboard materials obtained by bonding, to one or both surfaces of a corrugated paperboard, other paperboards. In addition, a laminated plate in which a plurality of these materials are bonded may be used.

In addition, various display devices such as an organic electro-luminescence (organic light emitting diode (OLED)) display, a liquid crystal display, a micro light emitting diode (LED) display, and an inorganic electroluminescence display, and projector screens can also be suitably used as the vibration plate 102 as long as they have flexibility.

In the electroacoustic transducer 100, it is preferable that the electrode layer of the piezoelectric vibrator 50 and the vibration plate 102 are not electrically connected to each other.

In a case where the electrode layer of the piezoelectric vibrator 50 and the vibration plate 102 are electrically connected to each other, there is a concern that troubles such as a short circuit may occur. Therefore, by adopting the configuration in which the electrode layer of the piezoelectric vibrator 50 and the vibration plate 102 are not electrically connected to each other, the risk of occurrence of failure can be reduced.

### <Piezoelectric Vibrator>

The piezoelectric vibrator is a piezoelectric actuator which converts electrical energy into mechanical energy.

Examples of the piezoelectric vibrator include lead zirconate titanate (PZT), lead lanthanum zirconate titanate (PLZT), barium titanate, zinc oxide, a solid solution of bismuth ferrite and barium titanate (BFBT), a vibrator using a ceramic piezoelectric body such as a piezo element as disclosed in JP2021-090167A, and polyvinylidene fluoride (PVDF).

### (Piezoelectric Film)

It is preferable that the piezoelectric vibrator has a piezoelectric film which includes a piezoelectric layer having piezoelectric characteristics and electrode layers provided on both surfaces of the piezoelectric layer.

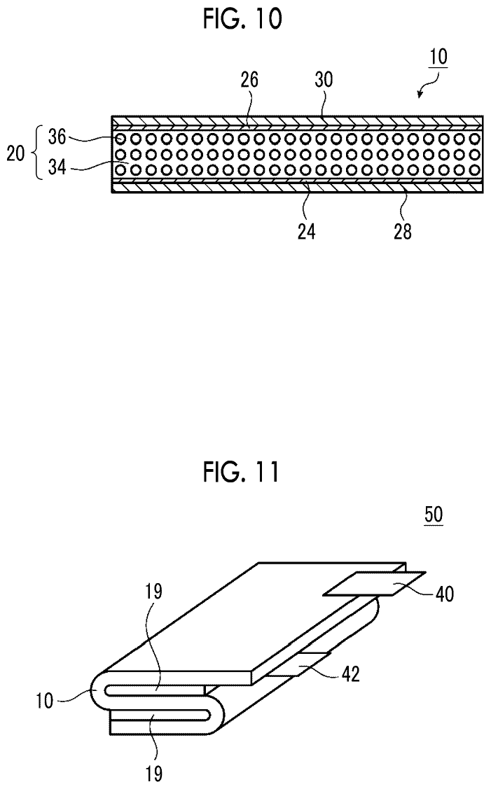

FIG. 10 shows an example of the piezoelectric film.

As shown in FIG. 10, the piezoelectric film 10 includes a piezoelectric layer 20, a first electrode layer 24 laminated on one surface of the piezoelectric layer 20, a first protective layer 28 laminated on the first electrode layer 24, a second electrode layer 26 laminated on the other surface of the piezoelectric layer 20, and a second protective layer 30 laminated the second electrode layer 26.

As the piezoelectric layer 20, various known piezoelectric layers can be used.

In the piezoelectric film 10, as conceptually shown in FIG. 10, the piezoelectric layer 20 is preferably a polymer-based piezoelectric composite material containing piezoelectric particles 36 in a matrix 34 containing a polymer material.

As a material of the matrix 34 (serving as a matrix and a binder) of the polymer-based piezoelectric composite material constituting the piezoelectric layer 20, it is preferable to use a polymer material having viscoelasticity at normal temperature. In the present specification, the “normal temperature” indicates a temperature range of approximately 0° C. to 50° C.

Here, it is preferable that the polymer-based piezoelectric composite material (piezoelectric layer 20) satisfies the following requirements.

### (i) Flexibility

For example, in a case of being gripped in a state of being loosely bent with a sense of document such as a newspaper and a magazine as a portable device, the polymer-based piezoelectric composite material is continuously subjected to large bending deformation from the outside at a comparatively slow vibration of less than or equal to a few Hz. At this time, in a case where the polymer-based piezoelectric composite material is rigid, large bending stress is generated to that extent, and a crack is generated at an interface between the polymer matrix and the piezoelectric particles, which may lead to breakage. Accordingly, the polymer-based piezoelectric composite material is required to have suitable flexibility. In addition, in a case where strain energy is diffused into the outside as heat, the stress can be relaxed. Therefore, the polymer-based piezoelectric composite material is required to have a suitably large loss tangent.

### (ii) Acoustic Quality

In a speaker, the piezoelectric particles vibrate at a frequency of an audio band of 20 Hz to 20 kHz, and vibration energy causes the entire polymer-based piezoelectric composite material (piezoelectric film) to vibrate integrally so that sound is reproduced. Therefore, in order to increase transmission efficiency of the vibration energy, the polymer-based piezoelectric composite material is required to have appropriate rigidity. In addition, in a case where frequency characteristics of the speaker are smooth, an amount of a change in acoustic quality decreases in a case where the lowest resonance frequency is changed in association with a change in curvature of the speaker. Therefore, the polymer-based piezoelectric composite material is required to have a suitably large loss tangent.

Accordingly, the polymer-based piezoelectric composite material is required to exhibit a behavior of being rigid with respect to a vibration of 20 Hz to 20 kHz and being flexible with respect to a vibration of less than or equal to a few Hz. In addition, the loss tangent of the polymer-based piezoelectric composite material is required to be suitably large with respect to the vibration of all frequencies of 20 kHz or less.

Furthermore, in a case of being used as a piezoelectric vibrator, it is preferable that the spring constant can be easily adjusted by lamination in accordance with the rigidity (hardness, stiffness, and spring constant) of the mating material (vibration plate) to be attached. In that regard, as a bonding layer for bonding the piezoelectric vibrator and the vibration plate is thinner, the energy efficiency can be increased.

In general, a polymer solid has a viscoelasticity relaxing mechanism, and a molecular movement with a large scale is observed as a decrease (relief) in a storage elastic modulus (Young's modulus) or a maximal value (absorption) in a loss elastic modulus along with an increase in temperature or a decrease in frequency. Among these, the relaxation due to a microbrown movement of a molecular chain in an amorphous region is referred to as main dispersion, and an extremely large relaxing phenomenon is observed. A temperature at which this main dispersion occurs is a glass transition point (Tg), and the viscoelasticity relaxing mechanism is most remarkably observed.

In the polymer-based piezoelectric composite material (piezoelectric layer 20), the polymer-based piezoelectric composite material exhibiting a behavior of being rigid with respect to the vibration of 20 Hz to 20 kHz and being flexible with respect to the slow vibration of less than or equal to a few Hz is achieved by using, as a matrix, a polymer material having a glass transition point at normal temperature, that is, a polymer material having viscoelasticity at normal temperature. In particular, from the viewpoint that such a behavior is suitably exhibited, it is preferable that a polymer material in which the glass transition point at a frequency of 1 Hz is at normal temperature, that is, in a range of 0° C. to 50° C. is used for a matrix of the polymer-based piezoelectric composite material.

As the polymer material having a viscoelasticity at normal temperature, various known materials can be used. It is preferable that a polymer material in which the maximal value of a loss tangent Tanδ at a frequency of 1 Hz according to a dynamic viscoelasticity test at normal temperature, that is, in a range of 0° C. to 50° C. is 0.5 or more is used as the polymer material.

In this manner, in a case where the polymer-based piezoelectric composite material is slowly bent due to an external force, stress concentration on the interface between the polymer matrix and the piezoelectric particles at the maximum bending moment portion is relaxed, and thus high flexibility can be expected.

In the polymer material having a viscoelasticity at normal temperature, it is preferable that a storage elastic modulus (E′) at a frequency of 1 Hz according to the dynamic viscoelasticity measurement is 100 MPa or more at 0° C. and 10 MPa or less at 50° C.

In this manner, a bending moment generated in a case where the polymer-based piezoelectric composite material is slowly bent due to the external force can be reduced, and at the same time, the polymer-based piezoelectric composite material can exhibit a behavior of being rigid with respect to an acoustic vibration of 20 Hz to 20 kHz.

In addition, it is more suitable that a relative permittivity of the polymer material having a viscoelasticity at normal temperature is 10 or more at 25° C. Accordingly, in a case where a voltage is applied to the polymer-based piezoelectric composite material, a higher electric field is applied to the piezoelectric particles in the matrix, and thus a large deformation amount can be expected.

However, in consideration of ensuring favorable moisture resistance and the like, it is suitable that the relative permittivity of the polymer material is 10 or less at 25° C.

Examples of the polymer material having a viscoelasticity at normal temperature and satisfying such conditions include cyanoethylated polyvinyl alcohol (cyanoethylated PVA), polyvinyl acetate, poly(vinylidene chloride-co-acrylonitrile), a polystyrene-vinyl polyisoprene block copolymer, polyvinyl methyl ketone, and polybutyl methacrylate. In addition, as these polymer materials, a commercially available product such as Hybrar 5127 (manufactured by Kuraray Co., Ltd.) can also be suitably used. Among these, as the polymer material, a material having a cyanoethyl group is preferably used, and cyanoethylated PVA is particularly preferably used.

Among these, as the polymer material having viscoelasticity at normal temperature, it is preferable to use a polymer material having a cyanoethyl group and particularly preferable to use cyanoethylated PVA. That is, in the present invention, as the matrix 34 of the piezoelectric layer 20, it is preferable to use a polymer material containing a cyanoethyl group and particularly preferable to use cyanoethylated PVA.

In the following description, the above-described polymer materials typified by cyanoethylated PVA will also be collectively referred to as “polymer material having viscoelasticity at normal temperature”.

These polymer materials having viscoelasticity at normal temperature may be used alone or in combination (mixture) of two or more kinds thereof.

The matrix 34 using such a polymer material having a viscoelasticity at normal temperature may use a plurality of polymer materials in combination as necessary.

That is, in order to control dielectric properties, mechanical properties, or the like, other dielectric polymer materials may be added to the matrix 34 as necessary, in addition to the viscoelastic material such as cyanoethylated PVA.

Examples of the dielectric polymer material which can be added thereto include fluorine-based polymers such as polyvinylidene fluoride, a vinylidene fluoride-tetrafluoroethylene copolymer, a vinylidene fluoride-trifluoroethylene copolymer, a polyvinylidene fluoride-trifluoroethylene copolymer, and a polyvinylidene fluoride-tetrafluoroethylene copolymer; polymers having a cyano group or a cyanoethyl group, such as a vinylidene cyanide-vinyl acetate copolymer, cyanoethyl cellulose, cyanoethyl hydroxysaccharose, cyanoethyl hydroxycellulose, cyanoethyl hydroxypullulan, cyanoethyl methacrylate, cyanoethyl acrylate, cyanoethyl hydroxyethyl cellulose, cyanoethyl amylose, cyanoethyl hydroxypropyl cellulose, cyanoethyl dihydroxypropyl cellulose, cyanoethyl hydroxypropyl amylose, cyanoethyl polyacrylamide, cyanoethyl polyacrylate, cyanoethyl pullulan, cyanoethyl polyhydroxymethylene, cyanoethyl glycidol pullulan, cyanoethyl saccharose, and cyanoethyl sorbitol; and synthetic rubber such as nitrile rubber and chloroprene rubber.

Among these, a polymer material having a cyanoethyl group is suitably used.

In addition, in the matrix 34 of the piezoelectric layer 20, the number of these dielectric polymer materials is not limited to one, and a plurality of kinds of dielectric polymer materials may be added.

In addition, for the purpose of controlling the glass transition point Tg, a thermoplastic resin such as a vinyl chloride resin, polyethylene, polystyrene, a methacrylic resin, polybutene, and isobutylene, and a thermosetting resin such as a phenol resin, a urea resin, a melamine resin, an alkyd resin, and mica may be added to the matrix 34 in addition to the dielectric polymer material.

Furthermore, for the purpose of improving pressure sensitive adhesiveness, a viscosity imparting agent such as rosin ester, rosin, terpene, terpene phenol, and a petroleum resin may be added.

In the matrix 34 of the piezoelectric layer 20, an addition amount of materials to be added, other than the polymer material having viscoelasticity, such as cyanoethylated PVA, is not particularly limited, but is preferably set to 30% by mass or less in terms of the proportion of the materials in the matrix 34.

In this manner, characteristics of the polymer material to be added can be exhibited without impairing the viscoelasticity relaxing mechanism in the matrix 34, so that preferred results such as an increase in permittivity, improvement of heat resistance, and improvement of adhesiveness between the piezoelectric particles 36 and the electrode layer can be obtained.

The piezoelectric layer 20 is a layer consisting of the polymer-based piezoelectric composite material containing the piezoelectric particles 36 in the matrix 34. The piezoelectric particles 36 are dispersed in the matrix 34. It is preferable that the piezoelectric particles 36 are dispersed uniformly (substantially uniform) in the matrix 34.

The piezoelectric particles 36 consist of ceramic particles having a perovskite type or wurtzite type crystal structure.

Examples of the ceramic particles constituting the piezoelectric particles 36 include lead zirconate titanate (PZT), lead lanthanum zirconate titanate (PLZT), barium titanate (BaTiO₃), zinc oxide (ZnO), and a solid solution (BFBT) of barium titanate and bismuth ferrite (BiFe₃).

A particle diameter of the piezoelectric particles 36 is not limited, and may be suitably selected depending on the size of the piezoelectric film 10, and the applications of the piezoelectric vibrator (laminated piezoelectric element) 50. The particle diameter of the piezoelectric particles 36 is preferably 1 to 10 μm.

By setting the particle diameter of the piezoelectric particles 36 to be within the above-described range, preferred results in terms of achieving both excellent piezoelectric characteristics and flexibility of the piezoelectric film 10 can be obtained.

The piezoelectric particles 36 in the piezoelectric layer 20 may be uniformly and regularly dispersed in the matrix 34, or may be uniformly dispersed in the matrix 34 even in a case where the piezoelectric particles 36 are irregularly dispersed in the matrix 34.

In the piezoelectric film 10, a ratio between an amount of the matrix 34 and an amount of the piezoelectric particles 36 in the piezoelectric layer 20 is not limited, and may be appropriately set according to the size and the thickness of the piezoelectric film 10 in the plane direction, the applications of the piezoelectric film 10, the characteristics required for the piezoelectric film 10, and the like.

A volume fraction of the piezoelectric particles 36 in the piezoelectric layer 20 is preferably 30% to 80%, more preferably 50% or more, and still more preferably 50% to 80%.

By setting the ratio between the amount of the matrix 34 and the amount of the piezoelectric particles 36 to be within the above-described range, preferred results in terms of achieving both of excellent piezoelectric characteristics and flexibility can be obtained.

In the piezoelectric film 10, a thickness of the piezoelectric layer 20 is not particularly limited and may be appropriately set according to the applications of the piezoelectric film 10, the number of lamination of the piezoelectric film 10 in the piezoelectric vibrator 50, the characteristics required for the piezoelectric film 10, and the like.

It is advantageous that the thickness of the piezoelectric layer 20 increases large in terms of stiffness such as the strength of rigidity of a so-called sheet-like material, but the voltage (potential difference) required to stretch and contract the piezoelectric film 10 increases by the same amount.

A thickness of the piezoelectric layer 20 is preferably 10 to 300 μm, more preferably 20 to 200 μm, and still more preferably 30 to 150 μm.

By setting the thickness of the piezoelectric layer 20 to be within the above-described ranges, preferred results in terms of achieving both ensuring of the rigidity and moderate elasticity can be obtained.

In addition, it is preferable that the piezoelectric layer 20 is subjected to a polarization treatment (poling) in the thickness direction.

In the piezoelectric film 10, the piezoelectric layer 20 is not limited to the polymer-based piezoelectric composite material containing the piezoelectric particles 36 in the matrix 34 consisting of a polymer material having viscoelasticity at normal temperature, such as cyanoethylated PVA, as described above.

That is, in the piezoelectric film 10, various known piezoelectric layers can be used as the piezoelectric layer.

As an example, a polymer-based piezoelectric composite material containing the same piezoelectric particles 36 in a matrix containing a dielectric polymer material such as polyvinylidene fluoride, a vinylidene fluoride-tetrafluoroethylene copolymer, and a vinylidene fluoride-trifluoroethylene copolymer described above, a piezoelectric layer consisting of polyvinylidene fluoride, a piezoelectric layer consisting of a fluororesin other than polyvinylidene fluoride, a piezoelectric layer obtained by laminating a film consisting of poly-L lactic acid and a film consisting of poly-D lactic acid, and the like are also available.

However, as described above, from the viewpoint that the polymer-based piezoelectric composite material can behave hard for vibrations at 20 Hz to 20 kHz and behave softly for slow vibrations at less than or equal to a few Hz, has excellent acoustic characteristics, and has excellent flexibility, a polymer-based piezoelectric composite material containing the piezoelectric particles 36 in the matrix 34 consisting of a polymer material having viscoelasticity at normal temperature, such as cyanoethylated PVA described above, is suitably used.

As shown in FIG. 10, the piezoelectric film 10 has a configuration in which the first electrode layer 24 is provided on one surface of the piezoelectric layer 20, the first protective layer 28 is provided thereon, the second electrode layer 26 is provided on the other surface of the piezoelectric layer 20, and the second protective layer 30 is provided thereon. Here, the first electrode layer 24 and the second electrode layer 26 form an electrode pair.

That is, the piezoelectric film 10 has a configuration in which both surfaces of the piezoelectric layer 20 are sandwiched between the electrode pair, that is, the first electrode layer 24 and the second electrode layer 26, and this laminate is sandwiched between the first protective layer 28 and the second protective layer 30.

In this way, in the piezoelectric film 10, a region sandwiched between the first electrode layer 24 and the second electrode layer 26 stretches and contracts according to an applied voltage.

The piezoelectric film 10 in the present invention may include, in addition to those layers, for example, a bonding layer for bonding the electrode layer and the piezoelectric layer 20 to each other, and a bonding layer for bonding the electrode layer and the protective layer to each other.

The bonding agent may be an adhesive or a pressure sensitive adhesive. In addition, the same material as the polymer material obtained by removing the piezoelectric particles 36 from the piezoelectric layer 20, that is, the matrix 34 can also be suitably used as the bonding agent. The bonding layer may be provided on both the first electrode layer 24 side and the second electrode layer 26 side, or may be provided only on one of the first electrode layer 24 side or the second electrode layer 26 side.

The first protective layer 28 and the second protective layer 30 in the piezoelectric film 10 have a function of coating the first electrode layer 24 and the second electrode layer 26 and imparting moderate rigidity and mechanical strength to the piezoelectric layer 20. That is, the piezoelectric layer 20 consisting of the matrix 34 and the piezoelectric particles 36 in the piezoelectric film 10 exhibits extremely excellent flexibility under bending deformation at a slow vibration, but may have insufficient rigidity or mechanical strength depending on the applications. As a compensation for this, the piezoelectric film 10 is provided with the first protective layer 28 and the second protective layer 30.

The first protective layer 28 and the second protective layer 30 are not limited and various sheet-like materials can be used, and suitable examples thereof include various resin films.

Among these, from the viewpoint of excellent mechanical characteristics and heat resistance, a resin film consisting of polyethylene terephthalate (PET), polypropylene (PP), polystyrene (PS), polycarbonate (PC), polyphenylene sulfite (PPS), polymethylmethacrylate (PMMA), polyetherimide (PEI), polyimide (PI), polyethylene naphthalate (PEN), triacetyl cellulose (TAC), a cyclic olefin-based resin, and the like is suitably used.

Thicknesses of the first protective layer 28 and the second protective layer 30 are not limited. In addition, the thicknesses of the first protective layer 28 and the second protective layer 30 are basically the same as each other, but may be different from each other.

Here, in a case where the rigidity of the first protective layer 28 and the second protective layer 30 is extremely high, not only is the stretch and contraction of the piezoelectric layer 20 constrained, but also the flexibility is impaired. Therefore, it is advantageous that the thicknesses of the first protective layer 28 and the second protective layer 30 decrease except for the case where the mechanical strength or favorable handleability as a sheet-like material is required.

In a case where the thicknesses of the first protective layer 28 and the second protective layer 30 in the piezoelectric film 10 are two times or less the thickness of the piezoelectric layer 20, preferred results in terms of achieving both ensuring of the rigidity and moderate elasticity can be obtained.

For example, in a case where the thickness of the piezoelectric layer 20 is 50 μm and the first protective layer 28 and the second protective layer 30 consist of PET, the thicknesses of the first protective layer 28 and the second protective layer 30 are preferably 100 μm or less, more preferably 50 μm or less, and still more preferably 25 μm or less.

In the piezoelectric film 10, the first electrode layer 24 is formed between the piezoelectric layer 20 and the first protective layer 28, and the second electrode layer 26 is formed between the piezoelectric layer 20 and the second protective layer 30. The first electrode layer 24 and the second electrode layer 26 are provided to apply a voltage to the piezoelectric layer 20 (piezoelectric film 10).

In the present invention, a material for forming the first electrode layer 24 and the second electrode layer 26 is not limited, and various conductors can be used. Specific examples thereof include metals such as carbon, palladium, iron, tin, aluminum, nickel, platinum, gold, silver, copper, titanium, chromium, and molybdenum, alloys thereof, laminates and composites of these metals and alloys, and indium tin oxide. Specific examples thereof also include conductive polymers such as polyethylene dioxythiophene-polystyrene sulfonic acid (PEDOT/PPS). Among these, copper, aluminum, gold, silver, platinum, or indium tin oxide is suitable as the first electrode layer 24 and the second electrode layer 26. Among these, from the viewpoint of the conductivity, the cost, and the flexibility, copper is more preferable.

In addition, a method of forming the first electrode layer 24 and the second electrode layer 26 is not limited, and various known methods, for example, a vapor-phase deposition method (a vacuum film forming method) such as vacuum vapor deposition or sputtering, a film forming method using plating, and a method of bonding a foil formed of the materials described above can be used.

Among these, particularly from the reason that the flexibility of the piezoelectric film 10 can be ensured, a thin film made of copper, aluminum, or the like, which is formed by vacuum vapor deposition, is suitably used as the first electrode layer 24 and the second electrode layer 26. Among these, a thin film made of copper, which is formed by vacuum vapor deposition, is particularly suitably used.

Thicknesses of the first electrode layer 24 and the second electrode layer 26 are not limited. In addition, the thicknesses of the first electrode layer 24 and the second electrode layer 26 are basically the same as each other, but may be different from each other.

Here, same as the first protective layer 28 and the second protective layer 30 described above, in a case where the rigidity of the first electrode layer 24 and the second electrode layer 26 is extremely high, not only the stretch and contraction of the piezoelectric layer 20 is constrained, but also the flexibility is impaired. Therefore, it is advantageous that the thicknesses of the first electrode layer 24 and the second electrode layer 26 decrease in a case where electric resistance is not extremely high.

In the piezoelectric film 10, from the viewpoint that the flexibility is not considerably impaired, it is suitable that a product of the thickness and the Young's modulus of the first electrode layer 24 and the second electrode layer 26 is less than a product of the thickness and the Young's modulus of the first protective layer 28 and the second protective layer 30.

For example, in a combination in which the first protective layer 28 and the second protective layer 30 consist of PET (Young's modulus: approximately 6.2 GPa) and the first electrode layer 24 and the second electrode layer 26 consist of copper (Young's modulus: approximately 130 GPa), in a case where the thicknesses of the first protective layer 28 and the second protective layer 30 are assumed to be 25 μm, the thicknesses of the first electrode layer 24 and the second electrode layer 26 are preferably 1.2 μm or less, more preferably 0.3 μm or less, and still more preferably 0.1 μm or less.

As described above, the piezoelectric film 10 has a configuration in which the piezoelectric layer 20 obtained by dispersing the piezoelectric particles 36 in the matrix 34 containing the polymer material is sandwiched between the first electrode layer 24 and the second electrode layer 26, and this laminate is sandwiched between the first protective layer 28 and the second protective layer 30.

In such a piezoelectric film 10, it is preferable that the maximal value of the loss tangent (tanδ) at a frequency of 1 Hz according to the dynamic viscoelasticity measurement is present at normal temperature, and it is more preferable that the maximal value at which the loss tangent is 0.1 or more is present at normal temperature.

In this manner, even in a case where the piezoelectric film 10 is subjected to large bending deformation at a relatively slow vibration of less than or equal to a few Hz from the outside, since the strain energy can be effectively diffused to the outside as heat, occurrence of cracks at the interface between the polymer matrix and the piezoelectric particles can be prevented.

In the piezoelectric film 10, it is preferable that the storage elastic modulus (E′) at a frequency of 1 Hz according to the dynamic viscoelasticity measurement is 10 to 30 GPa at 0° C. and 1 to 10 GPa at 50° C. The same applies to the conditions for the piezoelectric layer 20.

In such a manner, the piezoelectric film 10 may have large frequency dispersion in the storage elastic modulus (E′) at normal temperature. That is, the piezoelectric film can exhibit a behavior of being rigid with respect to the vibration of 20 Hz to 20 kHz and being flexible with respect to the vibration of less than or equal to a few Hz.

In addition, in the present invention, the storage elastic modulus (Young's modulus) and the loss tangent of the piezoelectric film 10, the piezoelectric layer 20, and the like may be measured by a known method. As an example, the measurement may be performed using a dynamic viscoelasticity measuring device DMS6100 (manufactured by SII Nanotechnology Inc.).

Examples of measurement conditions include conditions with a measurement frequency of 0.1 Hz to 20 Hz (0.1 Hz, 0.2 Hz, 0.5 Hz, 1 Hz, 2 Hz, 5 Hz, 10 Hz, and 20 Hz), a measurement temperature of −50° C. to 150° C., a temperature rising rate of 2° C./min (in a nitrogen atmosphere), a sample size of 40 mm×10 mm (including the clamped region), and a chuck-to-chuck distance of 20 mm.

In the laminated piezoelectric element 50, the first electrode layer 24 and the second electrode layer 26 of each piezoelectric film 10 are connected to a driving source which applies a driving voltage, that is, supplies a driving power (input signal) for stretching and contracting the piezoelectric film 10.

An example of a circuit of the drive source is as described above.

A method of leading out electrodes from the first electrode layer 24 and the second electrode layer 26 is not limited, and various known methods can be used.

Examples thereof include a method of connecting a conductor such as a copper foil to the first electrode layer 24 and the second electrode layer 26 and leading-out the electrodes to the outside, and a method of forming through-holes in the first protective layer 28 and the second protective layer 30 with a laser or the like, filling the through-holes with a conductive material, and leading-out the electrodes to the outside.

Examples of a suitable method of leading out the electrodes include the method described in JP2014-209724A and the method described in JP2016-015354A.

### (Laminated Piezoelectric Element)

The above-described piezoelectric film may be used as a piezoelectric vibrator in a form of a laminated piezoelectric element in which a plurality of layers of the piezoelectric film are laminated by folding the piezoelectric film one or more times.

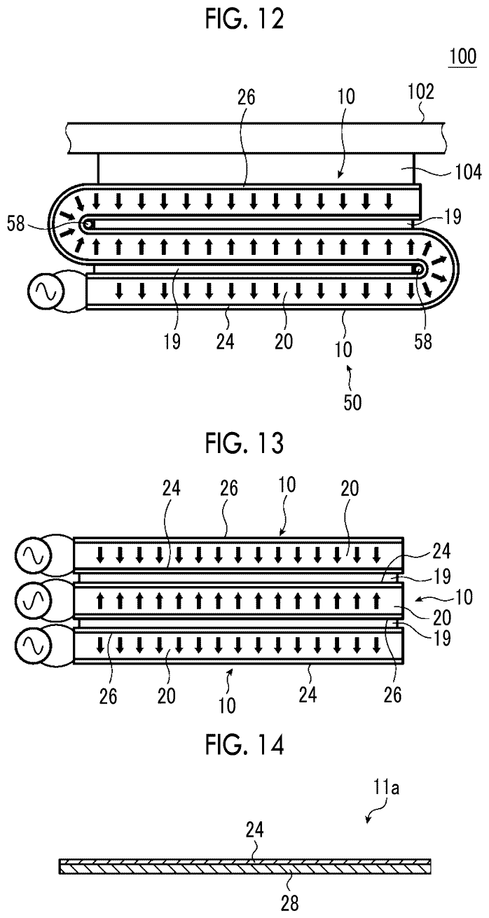

FIG. 11 is a perspective view schematically showing an example of the laminated piezoelectric element which is the piezoelectric vibrator. FIG. 12 is a side view of an electroacoustic transducer including the laminated piezoelectric element shown in FIG. 11.

An electroacoustic transducer 100 shown in FIG. 12 includes a laminated piezoelectric element (piezoelectric vibrator) 50, a vibration plate 102, and a bonding layer 104 disposed between the laminated piezoelectric element 50 and the vibration plate 102. The laminated piezoelectric element 50 and the vibration plate 102 are bonded to each other with the bonding layer 104. The vibration plate 102 is as described above.

In the example shown in FIGS. 11 and 12, the laminated piezoelectric element 50 is obtained by laminating three layers of the piezoelectric film 10 by folding one rectangular long piezoelectric film 10 twice in one direction. In FIG. 12 and FIG. 13 described below, the protective layer is not shown.

As shown in FIG. 12, a driving source is connected to the first electrode layer 24 and the second electrode layer 26 of the piezoelectric film 10 constituting the laminated piezoelectric element 50. In the laminated piezoelectric element 50 (piezoelectric film 10), the piezoelectric layer 20 is stretched and contracted to be driven as a piezoelectric material by applying a voltage (input signal) to the first electrode layer 24 and the second electrode layer 26. In a case where the laminated piezoelectric element 50 is driven, the laminated piezoelectric element 50 stretches and contracts in the plane direction, and the laminated piezoelectric element 50 bends the vibration plate 102 to which the laminated piezoelectric element 50 is bonded, and as a result, the vibration plate 102 is vibrated in the thickness direction to generate a sound. The vibration plate 102 is vibrated according to a magnitude of the driving voltage applied to the laminated piezoelectric element 50, and the electroacoustic transducer 100 generates ae sound according to the applied driving voltage.

In the examples shown in FIGS. 11 and 12, the laminated piezoelectric element 50 has a laminated portion in which three layers of the piezoelectric film 10 overlap each other in a plan view, and a protruding portion which protrudes outward from the laminated portion in the plane direction. That is, in the laminated piezoelectric element 50, in a case where one piezoelectric film 10 is folded two times, in FIG. 11, two layers from a lower layer side have almost the same length in the folding-back direction, a length of the piezoelectric film 10 as the uppermost layer is longer than the length of the piezoelectric film 10 as the other layers, and the protruding portion is provided such that one end in the folding-back direction does not overlap with the piezoelectric film 10 as the other layers.

In the example shown in FIG. 11, the laminated piezoelectric element 50 is formed by folding the piezoelectric film 10 twice and laminating three layers of the piezoelectric film 10, but the present invention is not limited thereto; and the laminated piezoelectric element may be formed by laminating two layers of the piezoelectric films or may be formed by laminating four or more layers of the piezoelectric films.

Layers of the piezoelectric film 10 adjacent to each other in the laminated portion are bonded to each other with a bonding layer 19.

As the bonding layer 19 for bonding the piezoelectric films, various known materials can be used as long as the adjacent piezoelectric films 10 can be bonded. As the bonding layer 19, the same material as the bonding layer for bonding the vibration plate and the laminated piezoelectric element, which will be described later, can be used.

In the present invention, the laminated portion is a region where two or more layers of the piezoelectric film overlap each other in a plan view, that is, in a case where the laminated piezoelectric element is viewed from above (or below) in FIG. 11. That is, in the examples shown in FIGS. 11 and 12, a region where three layers of the piezoelectric film 10 overlap each other is the laminated portion.

On the other hand, the protruding portion is a region where protrudes from the laminated portion in the plane direction, and is a region where does not overlap with other layers in a plan view. In the examples shown in FIGS. 11 and 12, the right end part of the uppermost layer is the protruding portion.

As shown in FIG. 11, the protruding portion is formed with a conductive wire 40 and a conductive wire 42, for connecting the first electrode layer 24 and the second electrode layer 26 (hereinafter, collectively referred to as an electrode layer), and an external electrode. As shown in FIG. 12, in a case where the piezoelectric film 10 includes a protective layer (the first protective layer 28 and the second protective layer 30), through-holes are formed in the protective layer (the first protective layer 28 and the second protective layer 30) in the region of the protruding portion to expose the electrode layer, and the connecting portion is provided to be electrically connected to each of the conductive wire 40 and the conductive wire 42. A method of forming the through-hole is not particularly limited, and a known method such as laser processing, dissolution removal using a solvent, or mechanical processing such as mechanical polishing may be performed according to a forming material of the protective layer.

A conductive wire filled with a known conductive material such as a conductive metal paste, for example, a silver paste, a conductive carbon paste, and a conductive nano ink is connected to the connecting portion and is connected to an external power supply.

A method of connecting the electrode layer and the conductive wire in the protruding portion is not limited, and various known methods can be used.

In the laminated piezoelectric element 50, the laminated piezoelectric element 50 is driven by applying a voltage to the electrode layer using the external power supply through the connecting portion provided in the protruding portion. In a case where the laminated piezoelectric element 50 is driven, the laminated piezoelectric element 50 stretches and contracts in the plane direction, and the laminated piezoelectric element 50 bends the vibration plate to which the laminated piezoelectric element 50 is bonded, and as a result, the vibration plate is vibrated to generate a sound. The vibration plate is vibrated according to a magnitude of a driving voltage applied to the laminated piezoelectric element 50, and generates the sound according to the driving voltage applied to the laminated piezoelectric element 50.

Here, in the example shown in FIG. 11, the laminated piezoelectric element has a configuration in which the piezoelectric film 10 is folded and laminated, but the present invention is not limited thereto.

FIG. 13 is a view showing an example of another configuration of the laminated piezoelectric element of the electroacoustic transducer according to the embodiment of the present invention.

The laminated piezoelectric element illustrated in FIG. 13 is obtained by laminating three layers of sheet-like piezoelectric films 10. Adjacent piezoelectric films 10 are bonded to each other with a bonding layer 19. A driving source for applying a driving voltage is connected to each piezoelectric film 10. In FIG. 13, the first protective layer and the second protective layer are omitted in order to simplify the drawing. However, in the laminated piezoelectric element shown in FIG. 13, as a preferred aspect, all the piezoelectric films 10 include both the first protective layer and the second protective layer.

However, the laminated piezoelectric element is not limited thereto, and a piezoelectric film including the protective layer and a piezoelectric film including no protective layer may be mixed. Furthermore, in a case where the piezoelectric film includes the protective layer, the piezoelectric film may include only the first protective layer or may include only the second protective layer. As an example, in the laminated piezoelectric element having a three-layer configuration as shown in FIG. 13, a configuration may be adopted in which the piezoelectric film as the uppermost layer in the drawing includes only the second protective layer on the second electrode layer 26, the piezoelectric film in the middle does not include the protective layer, and the piezoelectric film as the lowermost layer includes only the first protective layer on the first electrode layer 24.

The laminated piezoelectric element shown in FIG. 13 has, as a preferred aspect, a configuration in which a plurality of layers (three layers in the illustrated example) of the piezoelectric films 10 are laminated such that polarization directions (directions indicated by arrows in FIG. 13) of adjacent piezoelectric films 10 are opposite to each other, and the adjacent piezoelectric films 10 are bonded to each other with the bonding layer 19.

The laminated piezoelectric element may have a configuration in which a plurality of layers of the piezoelectric films 10 are laminated with the polarization directions of the adjacent piezoelectric films 10 being the same.

In the piezoelectric film 10, the polarity of the voltage to be applied to the piezoelectric layer 20 depends on the polarization direction. Therefore, regarding the polarity of the applied voltage, in the polarization directions indicated by the arrows, the polarity of the electrode layer on the side in a direction in which the arrows are directed (downstream side of the arrows) and the polarity of the electrode layer on the opposite side (upstream side of the arrows) are coincident with each other in all the piezoelectric films 10.

In the illustrated example, the electrode on the side in the direction in which the arrow indicating the polarization direction is directed is the first electrode layer 24 and the electrode on the opposite side is the second electrode layer 26, and the polarities of the first electrode layer 24 and the second electrode layer 26 are the same in all the piezoelectric films 10.

Therefore, in the laminated piezoelectric element in which the polarization directions of the piezoelectric layers 20 of the adjacent piezoelectric films 10 are opposite to each other as shown in FIG. 13, in the adjacent piezoelectric films 10, the first electrode layers 24 face each other on one surface and the second electrode layers 26 face each other on the other surface. Accordingly, in the laminated piezoelectric element shown in FIG. 13, even in a case where the electrode layers of the adjacent piezoelectric films 10 come into contact with each other, there is no risk of a short circuit.

In order to stretch and contract the laminated piezoelectric element with favorable energy efficiency, it is preferable to make the bonding layer 19 thin so that the bonding layer 19 does not interfere with the stretching and contracting of the piezoelectric layer 20. On the contrary, in the laminated piezoelectric element shown in FIG. 13, in which there is no risk of a short circuit even in a case where the electrode layers of the adjacent piezoelectric films 10 come into contact with each other, the bonding layer 19 may be omitted. In addition, even in a case where the bonding layer 19 is provided as the preferred aspect, the bonding layer 19 can be made extremely thin as long as a required bonding force can be obtained. Therefore, the laminated piezoelectric element can be stretched and contracted with high energy efficiency.

In the piezoelectric film 10, an absolute amount of stretch and contraction of the piezoelectric layer 20 in the thickness direction is very small, and the stretch and contraction of the piezoelectric film 10 is substantially only in the plane direction. Therefore, even in a case where the polarization directions of the piezoelectric films 10 to be laminated are opposite to each other, all the piezoelectric films 10 stretch and contract in the same direction as long as the polarities of the voltages applied to the first electrode layer 24 and the second electrode layer 26 are correct.

The polarization direction of the piezoelectric film 10 may be detected by a d33 meter or the like. Alternatively, the polarization direction of the piezoelectric film 10 may be known from processing conditions of the corona poling treatment, which will be described later.

In addition, in the laminated piezoelectric element shown in FIG. 13, it is preferable to produce a long (large area) piezoelectric film, and cut out the individual piezoelectric film 10 from the long piezoelectric film and laminate the piezoelectric films. In this case, all the plurality of piezoelectric films 10 forming the laminated piezoelectric element are the same.

However, the present invention is not limited thereto. That is, in the present invention, various configurations can be used as the laminated piezoelectric element, for example, a configuration in which piezoelectric films having different layer configurations, such as a piezoelectric film including the first protective layer and the second protective layer and a piezoelectric film not including the first protective layer and the second protective layer, are laminated, and a configuration in which piezoelectric films having different thicknesses of the piezoelectric layer 20 are laminated.

In addition, in the laminated piezoelectric element shown in FIGS. 11 and 12, the laminated piezoelectric element can be configured with only one long piezoelectric film 10, only one driving source is required for applying the driving voltage, and the electrode may be led out from the piezoelectric film 10 at one place.

Therefore, the number of components can be reduced, the configuration can be simplified, the reliability of the laminated piezoelectric element can be improved, and the cost can be reduced with respect to the laminated piezoelectric element in which a plurality of layers of the sheet-like piezoelectric films 10 as shown in FIG. 13 are laminated.

In addition, the piezoelectric film 10 is polarized in the thickness direction (direction indicated by the arrow in FIG. 12). By folding and laminating one piezoelectric film 10 polarized in the thickness direction, the polarization directions of the piezoelectric film 10 adjacent (facing) in a lamination direction are opposite directions as indicated by the arrows in FIG. 12. Therefore, in the laminated piezoelectric element formed by folding one piezoelectric film 10, between the layers of the adjacent piezoelectric films 10, the first electrode layers 24 face each other on one surface and the second electrode layers 26 face each other on the other surface. Accordingly, even in a case where the electrode layers of the adjacent piezoelectric films 10 come into contact with each other, there is no risk of a short circuit.

Same as the laminated piezoelectric element shown in FIG. 12, in the laminated piezoelectric element in which the piezoelectric film 10 is folded, it is preferable that a core rod 58 is brought into contact with the piezoelectric film 10 and inserted into a folded-back portion of the piezoelectric film 10.

The first electrode layer 24 and the second electrode layer 26 of the piezoelectric film 10 are made of a metal vapor deposition film or the like. In a case where the metal vapor deposition film is bent at an acute angle, cracks and the like are likely to occur, and thus the electrode layer may be broken. That is, in the laminated piezoelectric element shown in FIG. 12, cracks and the like are likely to occur in the electrode inside a bent portion.

On the contrary, in the laminated piezoelectric element in which the piezoelectric film 10 is folded, by inserting the core rod 58 into the folded-back portion of the piezoelectric film 10, the first electrode layer 24 and the second electrode layer 26 are prevented from being bent. Therefore, the occurrence of breakage can be suitably prevented.

### <Bonding Layer>

The bonding layer 104 may be a layer formed of an adhesive which has fluidity in a case of bonding and then is to be a solid, a layer formed of a pressure sensitive adhesive which is a gel-like (rubber-like) soft solid in a case of bonding and the gel-like state does not change thereafter, or a layer formed of a material having characteristics of both the adhesive and the pressure sensitive adhesive. In addition, the adhesive layer may be formed by applying a bonding agent having fluidity such as a liquid, or may also be formed by using a sheet-like bonding agent.

Here, in the electroacoustic transducer 100, the piezoelectric vibrator (laminated piezoelectric element) 50 stretches and contracts to bend and vibrate the vibration plate 102, thereby generating a sound. Therefore, in the electroacoustic transducer 100, it is preferable that the stretch and contraction of the piezoelectric vibrator is directly transmitted to the vibration plate 102. In a case where a substance having viscosity, which relieves vibration, is present between the vibration plate 102 and the piezoelectric vibrator 50, efficiency of transmitting the stretching and contracting energy of the piezoelectric vibrator 50 to the vibration plate 102 is lowered, and driving efficiency of the electroacoustic transducer 100 is also decreased.

In consideration of this point, it is preferable that the bonding layer 104 bonding the piezoelectric vibrator 50 and the vibration plate 102 is an adhesive layer consisting of an adhesive from which a solid and hard bonding layer 104 is obtained, rather than a pressure sensitive adhesive layer consisting of a pressure sensitive adhesive. As a more preferred bonding layer 104, specifically, a bonding layer consisting of a thermoplastic type adhesive such as a polyester-based adhesive and a styrene-butadiene rubber (SBR)-based adhesive is exemplified.

The adhesion, unlike pressure sensitive adhesion, is useful in a case where a high adhesion temperature is required. In addition, the thermoplastic type adhesive has “comparatively low temperature, short time, and strong adhesion”, which is suitable.

A thickness of the bonding layer 104 is not limited, and a thickness at which sufficient bonding strength (adhesive force or pressure sensitive adhesive force) can be obtained may be appropriately set depending on the material of the bonding layer 104.

Here, in the electroacoustic transducer 100, as the bonding layer 104 is thinner, the effect of transmitting the stretching and contracting energy (vibration energy) of the piezoelectric vibrator 50 to the vibration plate 102 is higher, and the energy efficiency is higher. In addition, in a case where the bonding layer 104 is thick and has high rigidity, there is also a possibility that the stretch and contraction of the piezoelectric vibrator 50 may be constrained.

In consideration of this point, it is preferable that the bonding layer 104 is thin. Specifically, the thickness of the bonding layer 104 is preferably 0.1 to 50 μm, more preferably 0.1 to 30 μm, and still more preferably 0.1 to 10 μm in terms of thickness after bonding.

In the electroacoustic transducer 100, the bonding layer 104 is provided as a preferred aspect, and is not an essential constituent element.

Therefore, the electroacoustic transducer 100 may not include the bonding layer 104, and the vibration plate 102 may be fixed to the piezoelectric vibrator 50 using a known compression-bonding unit, fastening unit, fixing unit, or the like. For example, in a case where a shape of the piezoelectric vibrator 50 is a rectangular shape in a plan view, the electroacoustic transducer may be configured by fastening four corners with members such as bolts and nuts, or the electroacoustic transducer may be configured by fastening the four corners and a center portion with members such as bolts and nuts.

However, in such a case, in a case where the driving voltage is applied from the driving source, the piezoelectric vibrator 50 stretches and contracts independently of the vibration plate 102, and in some cases, only the piezoelectric vibrator 50 bends, and the stretch and contraction of the piezoelectric vibrator 50 is not transmitted to the vibration plate 102. As described above, in a case where the piezoelectric vibrator 50 stretches and contracts independently of the vibration plate 102, the vibration efficiency of the vibration plate 102 due to the piezoelectric vibrator 50 decreases. As a result, the vibration plate 102 may not be sufficiently vibrated.

In consideration of this point, it is preferable that the vibration plate 102 and the piezoelectric vibrator 50 are bonded to each other with the bonding layer 104.

In addition, in the above-described laminated piezoelectric element, the vibration plate 102 is vibrated by stretching and contracting the plurality of laminated piezoelectric films 10 to generate a sound. Therefore, in the laminated piezoelectric element, it is preferable that the stretch and contraction of each piezoelectric film 10 is directly transmitted. In a case where a substance having viscosity, which relieves vibration, is present between the piezoelectric films 10, efficiency of transmitting the stretching and contracting energy of the piezoelectric film 10 is lowered, and driving efficiency of the laminated piezoelectric element is also decreased.

In consideration of this point, it is preferable that the bonding layer 19 for bonding the piezoelectric films 10 is an adhesive layer consisting of an adhesive from which a solid and hard bonding layer 19 is obtained, rather than a pressure sensitive adhesive layer consisting of a pressure sensitive adhesive. As a more preferred bonding layer 19, specifically, a bonding layer consisting of a thermoplastic type adhesive such as a polyester-based adhesive and a styrene-butadiene rubber (SBR)-based adhesive is suitably exemplified.

In the laminated piezoelectric element, a thickness of the bonding layer 19 is not limited, and a thickness capable of exhibiting sufficient bonding strength may be appropriately set depending on the forming material of the bonding layer 19.

Here, in the laminated piezoelectric element, as the bonding layer 19 is thinner, the effect of transmitting the stretching and contracting energy of the piezoelectric film 10 is higher, and the energy efficiency is higher. In addition, in a case where the bonding layer 19 is thick and has high rigidity, there is also a possibility that the stretch and contraction of the piezoelectric film 10 may be constrained.

In consideration of this point, it is preferable that the bonding layer 19 is thinner than the piezoelectric layer 20. That is, in the laminated piezoelectric element, the bonding layer 19 is preferably hard and thin. Specifically, the thickness of the bonding layer 19 is preferably 0.1 to 50 μm, more preferably 0.1 to 30 μm, and still more preferably 0.1 to 10 μm in terms of thickness after bonding.

In the laminated piezoelectric elements of the examples shown in FIGS. 12 and 13, since the polarization directions of the adjacent piezoelectric films are opposite to each other and there is no concern that the adjacent piezoelectric films 10 may be short-circuited, the bonding layer 19 can be made thin.

In the laminated piezoelectric element, in a case where a spring constant (thickness×Young's modulus) of the bonding layer 19 is high, there is a possibility that the stretching and contracting of the piezoelectric film 10 may be constrained. Therefore, it is preferable that the spring constant of the bonding layer 19 is less than or equal to the spring constant of the piezoelectric film 10.

Specifically, a product of the thickness of the bonding layer 19 and a storage elastic modulus (E′) at a frequency of 1 Hz according to the dynamic viscoelasticity measurement is preferably 2.0×10⁶ N/m or less at 0° C., and 1.0×10⁶ N/m or less at 50° C.

It is preferable that an internal loss of the bonding layer 19 at a frequency of 1 Hz according to the dynamic viscoelasticity measurement is 1.0 or less at 25° C. in a case of the bonding layer 19 consisting of a pressure sensitive adhesive, and is 0.1 or less at 25° C. in a case of the bonding layer 19 consisting of an adhesive.

In the laminated piezoelectric element, the bonding layer 19 is provided as a preferred aspect, and is not an essential constituent element.

Therefore, the laminated piezoelectric element may be configured by laminating the piezoelectric films 10 to be closely attached to each other using a known pressure bonding unit, fastening unit, fixing unit, or the like, without including the bonding layer 19. For example, in a case where the piezoelectric film 10 is rectangular, the laminated piezoelectric element may be configured by fastening four corners with bolts, nuts, and the like or the laminated piezoelectric element may be configured by fastening four corners and a center portion with bolts, nuts, and the like. Alternatively, the laminated piezoelectric element may be configured by laminating the piezoelectric films 10 and thereafter bonding the peripheral portion (end surface) with a pressure sensitive adhesive tape to fix the laminated piezoelectric films 10.

However, in this case, in a case where a driving voltage is applied from the power source, the individual piezoelectric films 10 stretch and contract independently, and in some cases, layers of the piezoelectric films 10 bend in opposite directions and form a void. As described above, in a case where the individual piezoelectric films 10 stretch and contract independently, the driving efficiency of the laminated piezoelectric element decreases, the degree of stretching and contracting of the entire laminated piezoelectric element decreases, and there is a possibility that an abutting vibration plate 102 or the like cannot be sufficiently vibrated. In particular, in a case where the layers of the piezoelectric films 10 bend in the opposite directions and form a void, the driving efficiency of the laminated piezoelectric element is greatly decreased.

In consideration of this point, it is preferable that the laminated piezoelectric element has the bonding layer 19 for bonding adjacent piezoelectric films 10 to each other, as the laminated piezoelectric element in the illustrated example.

Here, in a case where the electroacoustic transducer 100 has a configuration in which the laminated piezoelectric element is bonded to the vibration plate 102 as shown in FIG. 12, it is preferable that a product of the thickness of the laminated piezoelectric element and the storage elastic modulus at a frequency of 1 Hz and 25° C. according to the dynamic viscoelasticity measurement is 0.1 to 3 times a product of the thickness of the vibration plate 102 and the Young's modulus thereof.

As described above, the piezoelectric film 10 of the present invention has excellent flexibility in an environment at normal temperature, and the laminated piezoelectric element obtained by laminating the piezoelectric film 10 also has excellent flexibility in an environment at normal temperature.

In addition, the vibration plate 102 has a certain degree of rigidity. In a case where the laminated piezoelectric element having rigidity is combined with the vibration plate 102, the combination is hard and unlikely to be bent, which is disadvantageous in terms of flexibility of the electroacoustic transducer 100.

On the other hand, in the present invention, it is preferable that the product of the thickness of the laminated piezoelectric element and the storage elastic modulus at a frequency of 1 Hz and 25° C. according to the dynamic viscoelasticity measurement is preferably 3 times or less the product of the thickness of the vibration plate 102 and the Young's modulus thereof. That is, in the laminated piezoelectric element, the spring constant with respect to a slow movement is preferably three times or less that of the vibration plate 102.

With such a configuration, the electroacoustic transducer 100 exhibits a behavior of being flexible with respect to a slow movement due to an external force such as bending and rolling, that is, exhibits satisfactory flexibility with respect to a slow movement.

In the electroacoustic transducer 100, the product of the thickness of the laminated piezoelectric element and the storage elastic modulus at a frequency of 1 Hz and 25° C. according to the dynamic viscoelasticity measurement is more preferably two times or less, still more preferably one time or less, and particularly preferably 0.3 times or less the product of the thickness of the vibration plate 102 and the Young's modulus thereof.

In consideration of the material used for the laminated piezoelectric element, a preferable configuration of the laminated piezoelectric element, and the like, the product of the thickness of the laminated piezoelectric element and the storage elastic modulus at a frequency of 1 Hz and 25° C. according to the dynamic viscoelasticity measurement is preferably at least 0.1 times the product of the thickness of the vibration plate 102 and the Young's modulus.

In the electroacoustic transducer 100, the product of the thickness of the laminated piezoelectric element and the storage elastic modulus at a frequency of 1 kHz and 25° C. in the master curve obtained from the dynamic viscoelasticity measurement is preferably in a range of 0.3 to 10 times the product of the thickness of the vibration plate 102 and the Young's modulus thereof. That is, in the laminated piezoelectric element, the spring constant for a fast movement in a driven state is preferably in a range of 0.3 to 10 times that of the vibration plate 102.

As described above, the electroacoustic transducer 100 generates a sound by stretching and contracting the laminated piezoelectric element in the plane direction to vibrate the vibration plate 102. Therefore, it is preferable that the laminated piezoelectric element has a certain degree of rigidity (hardness, stiffness) with respect to the vibration plate 102 at a frequency of the audio band (20 Hz to 20 kHz).

The product of the thickness of the laminated piezoelectric element and the storage elastic modulus at a frequency of 1 kHz and 25° C. in the master curve obtained from the dynamic viscoelasticity measurement is set to preferably 0.3 times or more, more preferably 0.5 times or more, and still more preferably 1 time or more the product of the thickness of the vibration plate 102 and the Young's modulus thereof. That is, in the laminated piezoelectric element, the spring constant with respect to a fast movement is preferably 0.3 times or more, more preferably 0.5 times or more, and still more preferably 1 time or more that of the vibration plate 102.

In this manner, at a frequency of the audio band, the rigidity of the laminated piezoelectric element with respect to the vibration plate 102 is sufficiently ensured, and the electroacoustic transducer 100 can output a sound with a high sound pressure and high energy efficiency.

Meanwhile, in consideration of the materials available for the laminated piezoelectric element, a preferable configuration of the laminated piezoelectric element, and the like, the product of the thickness of the laminated piezoelectric element and the storage elastic modulus at a frequency of 1 kHz and 25° C. according to the dynamic viscoelasticity measurement is preferably 10 times or less the product of the thickness of the vibration plate 102 and the Young's modulus thereof.

As is clear from the above description, the product of the thickness of the laminated piezoelectric element (piezoelectric vibrator) and the storage elastic modulus at a frequency of 1 Hz and 25° C. according to the dynamic viscoelasticity measurement is greatly affected by not only the thickness of the bonding layer 19 but also the physical properties of the bonding layer 19 such as the storage elastic modulus.

On the other hand, the product of the thickness of the vibration plate 102 and the Young's modulus, that is, the spring constant of the vibration plate greatly affects not only the thickness of the vibration plate but also the physical properties of the vibration plate.

Therefore, in the present invention, in order to satisfy the condition that the product of the thickness of the laminated piezoelectric element and the storage elastic modulus of the laminated piezoelectric element at a frequency of 1 Hz and 25° C. according to the dynamic viscoelasticity measurement is 0.1 to 3 times the product of the thickness of the vibration plate 102 and the Young's modulus thereof, the thickness and material of the bonding layer 19 and the thickness and material of the vibration plate are important. In addition, in the present invention, in order to satisfy the condition that the product of the thickness of the laminated piezoelectric element and the storage elastic modulus of the laminated piezoelectric element at a frequency of 1 kHz and 25° C. is 0.3 to 10 times the product of the thickness of the vibration plate 102 and the Young's modulus thereof, the thickness and the material of the bonding layer 19 and the thickness and the material of the vibration plate 102 are also important.

That is, in the present invention, in a case where the electroacoustic transducer has a configuration in which the vibration plate 102 is provided, it is preferable to appropriately select the thickness and the material of the bonding layer 19 and the thickness and the material of the vibration plate 102 so as to satisfy the above-described conditions.

In other words, in the present invention, by appropriately selecting the thickness and material of the bonding layer 19 and the thickness and material of the vibration plate 102 according to the properties and the like of the piezoelectric film 10, it is possible to appropriately satisfy the condition that the product of the thickness of the laminated piezoelectric element and the storage elastic modulus of the laminated piezoelectric element at a frequency of 1 Hz and 25° C. according to the dynamic viscoelasticity measurement is 0.1 to 3 times the product of the thickness of the vibration plate 102 and the Young's modulus, and/or the condition that the product of the thickness of the laminated piezoelectric element and the storage elastic modulus of the laminated piezoelectric element at a frequency of 1 kHz and 25° C. is 0.3 to 10 times the product of the thickness of the vibration plate 102 and the Young's modulus thereof.

The same applies to the case in which the single-layer piezoelectric film 10 is used as the piezoelectric vibrator instead of the laminated piezoelectric element with respect to the product of the thickness and the storage elastic modulus described above.

### <Production Method of Piezoelectric Film>

Next, an example of a manufacturing method of the piezoelectric film 10 will be described with reference to FIGS. 14 to 16.

First, as shown in FIG. 14, a sheet-like material 11a in which the first electrode layer 24 has been formed on a surface of the first protective layer 28 is prepared. Furthermore, as conceptually shown in FIG. 16, a sheet-like material 11c in which the second electrode layer 26 has been formed on a surface of the second protective layer 30 is prepared.

The sheet-like material 11a may be produced by forming a copper thin film or the like as the first electrode layer 24 on the surface of the first protective layer 28 using vacuum vapor deposition, sputtering, plating, or the like. Similarly, the sheet-like material 11c may be produced by forming a copper thin film or the like as the second electrode layer 26 on the surface of the second protective layer 30 using vacuum vapor deposition, sputtering, plating, or the like.

Alternatively, a commercially available sheet-like material in which a copper thin film or the like is formed on a protective layer may be used as the sheet-like material 11a and/or the sheet-like material 11c.

The sheet-like material 11a and the sheet-like material 11c may have the same configuration or different configurations.

In a case where the protective layer is extremely thin and thus the handleability is degraded, the protective layer with a separator (temporary support) may be used as necessary.

PET having a thickness of 25 to 100 μm, or the like can be used as the separator. The separator may be removed after thermal compression bonding of the electrode layer and the protective layer.

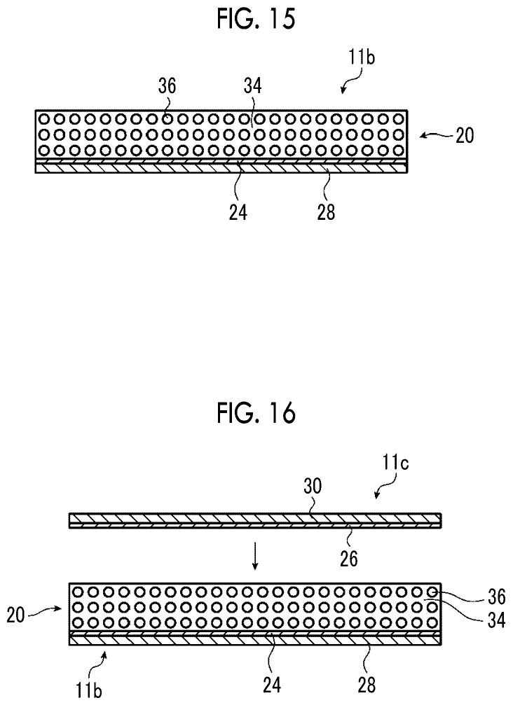

Next, as shown in FIG. 15, the first electrode layer 24 of the sheet-like material 11a is coated with a coating material (coating composition) forming the piezoelectric layer 20, and the coating material is cured to form the piezoelectric layer 20. In this manner, a laminate 11b in which the sheet-like material 11a and the piezoelectric layer 20 are laminated is produced.

The piezoelectric layer 20 can be formed by various methods depending on the forming material of the piezoelectric layer 20.

As an example, first, the coating material is prepared by dissolving the above-described polymer material such as cyanoethylated PVA in an organic solvent, adding the piezoelectric particles 36 such as PZT particles thereto, and stirring the solution.

The organic solvent is not limited, and various organic solvents such as dimethylformamide (DMF), methyl ethyl ketone (MEK), and cyclohexanone can be used.

In a case where the sheet-like material 11a is prepared and the coating material is prepared, the coating material is cast (applied) onto the sheet-like material 11a, and the organic solvent is evaporated and dried. In this manner, as shown in FIG. 15, the laminate 11b in which the first electrode layer 24 is provided on the first protective layer 28 and the piezoelectric layer 20 is laminated on the first electrode layer 24 is produced.

A casting method of the coating material is not limited, and all known methods (coating devices) such as a bar coater, a slide coater, and a doctor knife can be used.

Alternatively, in a case where the polymer material is a material which can be heated and melted, the laminate 11b as shown in FIG. 15 may be produced by heating and melting the polymer material to produce a melt obtained by adding the piezoelectric particles 36 to the melted material, extruding the melt on the sheet-like material 11a shown in FIG. 14 in a sheet shape by carrying out extrusion molding or the like, and cooling the laminate.

As described above, in the piezoelectric layer 20, a polymer piezoelectric material such as polyvinylidene fluoride (PVDF) may be added to the matrix 34, in addition to the polymer material having viscoelasticity at normal temperature.

In a case where the polymer piezoelectric material is added to the matrix 34, the polymer piezoelectric material to be added to the above-described coating material may be dissolved. Alternatively, the polymer piezoelectric material to be added may be added to the heated and melted polymer material having viscoelasticity at normal temperature so that the polymer piezoelectric material is heated and melted.

After forming the piezoelectric layer 20, a calender treatment may be performed as necessary. The calender treatment may be performed once or a plurality of times. As is well known, the calender treatment is a treatment in which the surface to be treated is pressed while being heated by a heating press, a heating roller, or the like to flatten the surface.

The calender treatment may be performed after a polarization treatment described later. However, in a case where the calender treatment is performed after the polarization treatment is performed, the piezoelectric particles 36 pushed in by the pressure rotate, which may decrease effect of the polarization treatment. In consideration of this point, it is preferable that the calender treatment is performed before the polarization treatment.

Next, the piezoelectric layer 20 of the laminate 11b including the first electrode layer 24 on the first protective layer 28 and including the piezoelectric layer 20 formed on the first electrode layer 24 is subjected to a polarization treatment (poling). The polarization treatment of the piezoelectric layer 20 may be performed before the calender treatment, but it is preferable that the polarization treatment is performed after the calender treatment.

A method of performing the polarization treatment on the piezoelectric layer 20 is not limited, and a known method can be used. For example, electric field poling in which a DC electric field is directly applied to a target to be subjected to the polarization treatment is exemplified. In a case of performing the electric field poling, the electric field poling treatment may be performed using the first electrode layer 24 and the second electrode layer 26 by forming the second electrode layer 26 before the polarization treatment.

In addition, in the piezoelectric film 10 of the present invention, it is preferable that the polarization treatment is performed in the thickness direction instead of the plane direction of the piezoelectric layer 20.

Next, as shown in FIG. 16, the sheet-like material 11c which has been prepared in advance is laminated on the piezoelectric layer 20 side of the laminate 11b which has been subjected to the polarization treatment, such that the second electrode layer 26 faces the piezoelectric layer 20.

Furthermore, the piezoelectric film 10 as shown in FIG. 10 is produced by subjecting the laminate to a thermal compression bonding using a heating press device, a heating roller, or the like such that the first protective layer 28 and the second protective layer 30 are sandwiched, and bonding the laminate 11b on the sheet-like material 11c.

Alternatively, the piezoelectric film 10 may be produced by bonding and preferably further compression-bonding the laminate 11b and the sheet-like material 11c to each other using an adhesive.

Such a piezoelectric film 10 may be produced using the cut sheet-like material 11a and the cut sheet-like material 11c, or may be produced using Roll to Roll.

The produced piezoelectric film may be cut into a desired shape according to various applications.

The piezoelectric film 10 to be produced in the above-described manner is polarized in the thickness direction instead of the plane direction, and thus excellent piezoelectric characteristics are obtained even in a case where a stretching treatment is not performed after the polarization treatment. Therefore, the piezoelectric film 10 has no in-plane anisotropy as a piezoelectric characteristic, and stretches and contracts isotropically in all directions in the plane direction in a case where a driving voltage is applied.

### Second Embodiment

Here, the electroacoustic transducer may be an electroacoustic transducer including a vibration plate and a vibrator group consisting of a plurality of piezoelectric vibrators arranged on one surface of the vibration plate, in which the vibration plate is curved in an arrangement direction of the plurality of piezoelectric vibrators of the vibrator group.

Furthermore, in the electroacoustic transducer, it is preferable that, in a case where an interval between adjacent piezoelectric vibrators of the plurality of piezoelectric vibrators is denoted by d, a distance from a central position of the vibration plate in an arrangement direction of the piezoelectric vibrators to the piezoelectric vibrator on a center side and a viewing position is denoted by L₁, and a distance from the piezoelectric vibrator on an outer side to the viewing position is denoted by L₂, a range of L₁×0.9<L₂<L₁×1.1 is satisfied.

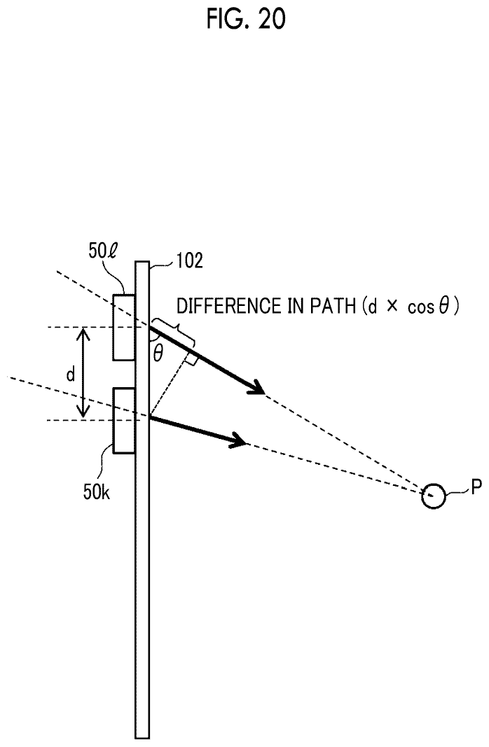

First, the difference in path will be described with reference to FIG. 20. In FIG. 20, for the sake of description, only two piezoelectric vibrators are shown, but the same applies to a case where three or more piezoelectric vibrators are provided.

As shown in FIG. 20, in a case where piezoelectric vibrators (50k, 50l) are arranged on the flat vibration plate 102, a distance from the vibration plate 102 (electroacoustic transducer) to a viewing position P spaced apart from the vibration plate 102 by a predetermined distance is different for each piezoelectric vibrator. Assuming that an interval between the piezoelectric vibrator 50k and the piezoelectric vibrator 50l is d, and an angle formed between a line segment connecting the piezoelectric vibrator 50l on the side far from the viewing position P and the viewing position P and the vibration plate 102 is θ, a difference b in path is represented by b=d× cosθ.

At a wavelength at which the difference b in path is an odd multiple of half a wavelength, phase interference occurs between sound wave emitted from the piezoelectric vibrator 50k and sound wave emitted from the piezoelectric vibrator 50l, and cancellation occurs. Therefore, even in a case where the number of piezoelectric vibrators is increased, the sound pressure is not improved and may be conversely decreased.

From the expression of the difference b in path, the difference b in path can be reduced by reducing the interval d between the piezoelectric vibrators, and the point sound source can be approached, but there is a physical limit to bringing the piezoelectric vibrators close to each other.

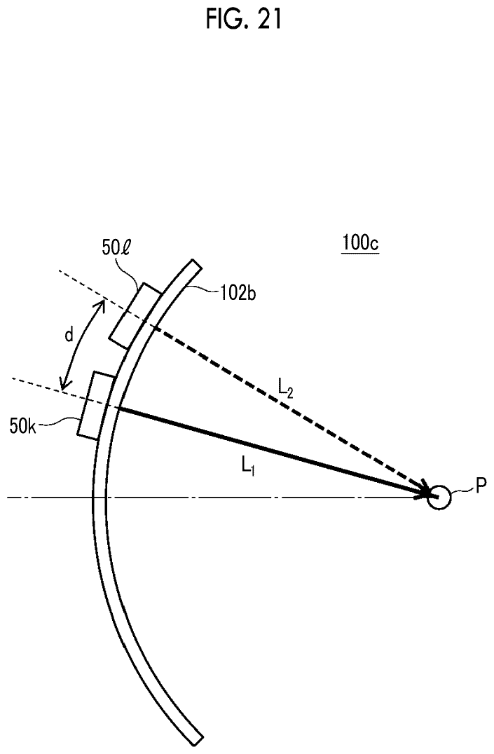

On the other hand, an electroacoustic transducer 100c shown in FIG. 21 includes a vibration plate 102b and a vibrator group consisting of a plurality of piezoelectric vibrators (50k, 50l) arranged on one surface of the vibration plate 102b, and the vibration plate 102b is curved in an arrangement direction of the plurality of piezoelectric vibrators (50k, 50l), that is, in an up-down direction in the drawing. In addition, the vibration plate 102b is curved to be recessed toward the viewing position P side. In FIG. 21, for the sake of description, only two piezoelectric vibrators are shown, but three or more piezoelectric vibrators may be provided.

In this way, by bending the vibration plate 102b, the difference in distance from each piezoelectric vibrator (50k, 50l) to the viewing position P, that is, the difference in path can be reduced, and thus the occurrence of phase interference regardless of the wavelength can be suppressed. Therefore, in the configuration in which the plurality of piezoelectric vibrators are provided, the sound pressure is not decreased, and the sound pressure can be improved by the addition effect.

Here, the viewing position P is a position of a user assumed in a case where the electroacoustic transducer is used, and is basically located on a center line in a horizontal direction of a display in a case where there is one viewer. For example, in a case where the electroacoustic transducer is used in combination with a display, an optimum viewing distance is set according to the size of the display, and thus the viewing position P may be set according to the viewing distance.

Alternatively, the electroacoustic transducer (or the display in which the electroacoustic transducer is incorporated) may be configured to include a drive unit capable of changing the curved state (curvature radius) of the vibration plate 102b and a sensor for measuring the distance to the user, such as a human sensor, to specify the position (viewing position P) of the user by the sensor and change the curved state (curvature radius) of the vibration plate 102b according to the specified viewing position.

Here, in a case of viewing alone, a viewing position on the front center line is basically preferable; but in a case where the viewing position deviates from the center line, an offset amount can be detected by the sensor, so that the difference b in path may be small (L₁ and L₂ described later satisfy a range described later), and in this case, the curve may be asymmetrical left and right.

In addition, a configuration may be adopted in which the user can optionally set the curved state (curvature radius) of the vibration plate 102b.

In addition, a curvature radius R of the curved vibration plate 102b may be set such that the distance from each piezoelectric vibrator (50k, 50l) to the viewing position P is substantially the same.

Specifically, as shown in FIG. 21, in an arrangement direction of the plurality of piezoelectric vibrators, in a case where a distance from a central position of the vibration plate to the piezoelectric vibrator 50k on a center side and the viewing position is denoted by L₁, and a distance from the piezoelectric vibrator 50l on an outer side than the piezoelectric vibrator 50k on the center side to the viewing position is denoted by L₂, a range of L₁×0.9<L₂<L₁×1.1 is satisfied.

By changing the curvature of the vibration plate 102b, the distances (L₁, L₂) from each piezoelectric vibrator (50k, 50l) to the viewing position P can be set to be within the above-described range, that is, to be substantially the same. By reducing the difference between the distance L₁ and the distance L₂, that is, the difference in path, it is possible to suppress the occurrence of phase interference regardless of the wavelength.

In the example shown in FIG. 21, the configuration in which two piezoelectric vibrators are provided has been described, but in a case where three or more piezoelectric vibrators are provided, it is preferable that the distance L₂ from the piezoelectric vibrator on the outer side with respect to the distance L₁ from the piezoelectric vibrator closest to the center side to the viewing position satisfies the above-described range.

### Third Embodiment

Here, the electroacoustic transducer may be an electroacoustic transducer including a vibration plate and a vibrator group consisting of a plurality of piezoelectric vibrators arranged on one surface of the vibration plate, in which, in a case where an interval between adjacent piezoelectric vibrators of the plurality of piezoelectric vibrators is denoted by d, a distance from a central position of the vibration plate in an arrangement direction of the piezoelectric vibrators to the piezoelectric vibrator on a center side and a viewing position is denoted by L₁, and a distance from the piezoelectric vibrator on an outer side to the viewing position is denoted by L₂, an input timing of the input signal to the piezoelectric vibrator on the outer side is set to be earlier than an input timing of the input signal to the piezoelectric vibrator on the center side by a time t=(L₂−L₁)/c.

Here, c (m/s) is a speed of sound.

As described above, in a case where piezoelectric vibrators (50k, 50l) are arranged on the flat vibration plate 102, a distance from the vibration plate 102 (electroacoustic transducer) to a viewing position P spaced apart from the vibration plate 102 by a predetermined distance is different for each piezoelectric vibrator, and the difference b in path=d× cosθ occurs.

Basically, the same signal is input to each piezoelectric vibrator (50k, 50l) included in the same vibrator group, but in a case where each piezoelectric vibrator is driven at the same timing, there is the difference b in path. Therefore, for example, the time taken for the sound wave emitted from the piezoelectric vibrator 50k to reach the viewing position P is different from the time taken for the sound wave emitted from the piezoelectric vibrator 50l to reach the viewing position P. In this case, as described above, at a wavelength at which the difference b in path is an odd multiple of half a wavelength, phase interference occurs between sound wave emitted from the piezoelectric vibrator 50k and sound wave emitted from the piezoelectric vibrator 50l, and cancellation occurs. Therefore, even in a case where the number of piezoelectric vibrators is increased, the sound pressure is not improved and may be conversely decreased.

Meanwhile, the input timing of the input signal to the piezoelectric vibrator 50l at a longer distance from the viewing position P is set to be earlier than the input timing of the input signal to the piezoelectric vibrator 50k at a shorter distance from the viewing position P, so that a timing at which the sound wave emitted from the piezoelectric vibrator 50l reaches the viewing position P and a timing at which the sound wave emitted from the piezoelectric vibrator 50k reaches the viewing position P are substantially the same.

Specifically, in a case where a distance from the piezoelectric vibrator 50k to the viewing position P is denoted by L₁, a distance from the piezoelectric vibrator 50l to the viewing position P is denoted by L₂, and a speed of sound is denoted by c (m/s), the timing at which the sound wave emitted from the piezoelectric vibrator 50l reaches the viewing position P and the timing at which the sound wave emitted from the piezoelectric vibrator 50k reaches the viewing position P can be substantially the same by making an input timing of the signal to the piezoelectric vibrator 50l earlier by a time t=(L₂−L₁)/c.

As a result, in the configuration in which the plurality of piezoelectric vibrators are arranged on the vibration plate, it is possible to suppress the occurrence of phase interference regardless of the wavelength. Therefore, the sound pressure is not decreased, and the sound pressure can be improved by the addition effect.

The processing of shifting the input timing of the signal for each piezoelectric vibrator may be performed using DPS or the like.

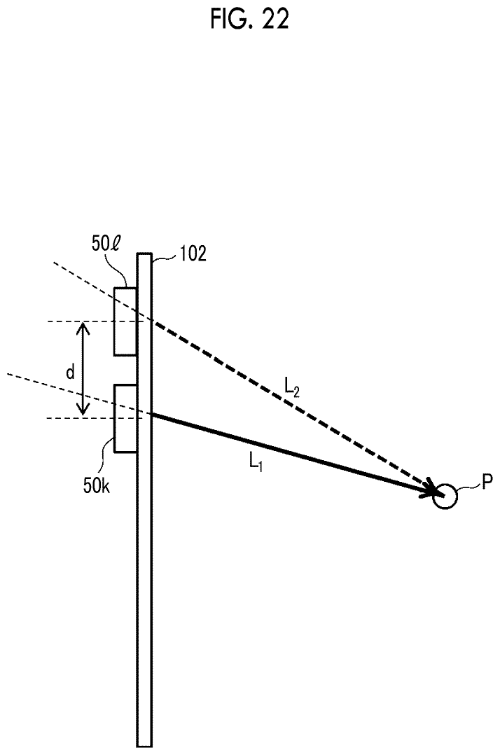

Here, in the example shown in FIG. 22, the two piezoelectric vibrators have been described, but even in a case where the vibrator group includes three or more piezoelectric vibrators, the input timing of the signal to each piezoelectric vibrator may be set to the time t according to the difference in path of each piezoelectric vibrator with respect to the distance between the reference piezoelectric vibrator and the viewing position P, with the piezoelectric vibrator having the shortest distance to the viewing position P, that is, the piezoelectric vibrator on the center side of the vibration plate as a reference.

In addition, a configuration may be adopted in which the electroacoustic transducer (or the display in which the electroacoustic transducer is incorporated) includes a sensor which measures a distance to a user, such as a human sensor, the position (viewing position P) of the user is specified by the sensor, a difference in path of each piezoelectric vibrator with respect to a distance between the reference piezoelectric vibrator and the viewing position P is calculated with the piezoelectric vibrator having the shortest distance to the viewing position P as a reference, and an input timing (time t) of a signal to each piezoelectric vibrator is set.

In the electroacoustic transducer according to the embodiment of the present invention, the first embodiment and second embodiment described above may be combined, the first embodiment and third embodiment described above may be combined, the second embodiment and third embodiment described above may be combined, or the first to third embodiments described above may be combined.

For example, in a configuration of including a vibration plate and a vibrator group consisting of a plurality of piezoelectric vibrators arranged on one surface of the vibration plate, the plurality of piezoelectric vibrators may belong to any one of a first group to an n-th group, an upper limit frequency of a frequency band of an input signal input to the piezoelectric vibrator may be different for each group, in a case where upper limit frequencies for each group are denoted by f₁ to fₙ, the upper limit frequencies may gradually decrease from the upper limit frequency f₁ in the first group to the upper limit frequency fₙ in the n-th group, and the vibration plate may be curved in an arrangement direction of the plurality of piezoelectric vibrators of the vibrator group.

Alternatively, for example, in a configuration of including a vibration plate and a vibrator group consisting of a plurality of piezoelectric vibrators arranged on one surface of the vibration plate, the plurality of piezoelectric vibrators may belong to any one of a first group to an n-th group, an upper limit frequency of a frequency band of an input signal input to the piezoelectric vibrator may be different for each group, in a case where upper limit frequencies for each group are denoted by f₁ to fₙ, the upper limit frequencies may gradually decrease from the upper limit frequency f₁ in the first group to the upper limit frequency fₙ in the n-th group, and in the plurality of piezoelectric vibrators of the vibrator group, in a case where a distance from one piezoelectric vibrator to the viewing position is longer than a distance from the other piezoelectric vibrator to the viewing position by a difference in path (L₂−L₁) (m), an input timing of an input signal to the other piezoelectric vibrator may be set to be earlier than an input timing of an input signal to one piezoelectric vibrator by a time t=(L₂−L₁)/c.

For example, in the second embodiment in which the vibration plate is curved, in a case where the curvature radius of the vibration plate is excessively small, there is a concern that the resonance frequency of the vibration plate may be increased and the sound pressure in the low frequency band may be decreased. Therefore, in the second embodiment, a configuration may be adopted in which the phase interference is suppressed by setting the curvature radius of the vibration plate to such a degree that the resonance frequency of the vibration plate is not excessively high, and further combining the first embodiment and/or the third embodiment.

In addition, for example, in a configuration including the third embodiment, the electroacoustic transducer (or the display in which the electroacoustic transducer is incorporated) may include a drive unit capable of changing the curved state (curvature radius) of the vibration plate, and in a case where the curvature radius of the vibration plate is changed, the difference in path (L₂−L₁) of each piezoelectric vibrator with respect to the distance between the reference piezoelectric vibrator and the viewing position P may be calculated, and the input timing of the signal to each piezoelectric vibrator may be set to the time t.

In addition, for example, in the configuration in which the electroacoustic transducer (or the display in which the electroacoustic transducer is incorporated) includes a drive unit capable of changing the curved state (curvature radius) of the vibration plate and includes a sensor which measures a distance to a user, in a case where the sensor detects one user, a configuration may be adopted in which the occurrence of the phase interference is suppressed by the configuration of the second embodiment (or a combination of the second embodiment and the first embodiment and/or the third embodiment); and in a case where the sensor detects two or more users, a configuration may be adopted in which the vibration plate is not curved or is slightly curved, and the occurrence of the phase interference is suppressed by combining the first embodiment and/or the third embodiment.

Alternatively, for example, in a configuration including the first embodiment, a configuration may be adopted in which the electroacoustic transducer (or the display in which the electroacoustic transducer is incorporated) includes a drive unit capable of changing the curved state (curvature radius) of the vibration plate, a difference in path (L₂−L₁) of each piezoelectric vibrator with respect to the distance between the reference piezoelectric vibrator and the viewing position P is calculated in a case where the curvature radius of the vibration plate is changed, a frequency at which cancellation occurs due to the difference in path (L₂−L₁) is calculated, and the upper limit frequency of the signal input for each group, that is, the cutoff frequency of the low-pass filter is changed according to the frequency. In a case where the low-pass filter function using DPS is used, the cutoff frequency of the low-pass filter can be changed immediately.

Hereinbefore, the electroacoustic transducer according to the embodiment of the present invention has been described in detail, but the present invention is not limited to the above-described examples and various improvements and changes can be made without departing from the spirit of the present invention.

### EXAMPLES

Hereinafter, the present invention will be described in more detail with reference to specific examples of the present invention. The present invention is not limited to the examples, and the materials, the used amounts, the proportions, the treatment contents, the treatment procedures, and the like shown in the following examples can be appropriately changed within a range not departing from the scope of the present invention.

### Example 1

### [Production of Piezoelectric Film]

A piezoelectric film was produced by the method shown in FIGS. 14 to 16 described above.

First, cyanoethylated PVA (CR-V manufactured by Shin-Etsu Chemical Co., Ltd.) was dissolved in dimethylformamide (DMF) at the following compositional ratio. Thereafter, PZT particles as piezoelectric particles were added to the solution at the following compositional ratio, and the solution was stirred using a propeller mixer (rotation speed: 2000 rpm), thereby preparing a coating material for forming a piezoelectric layer.
PZT Particles: 300 parts by mass
Cyanoethylated PVA: 30 parts by mass
DMF: 70 parts by mass

Particles obtained by sintering commercially available PZT raw material powder at 1000° C. to 1200° C. and then crushing and classifying the sintered powder to have an average particle diameter of 5 μm were used as the PZT particles.

On the other hand, a sheet-like material obtained by performing vacuum vapor deposition on a copper thin film having a thickness of 0.3 μm was prepared on a PET film having a thickness of 4 μm. That is, in the present example, the first electrode layer and the second electrode layer were copper-deposited thin films having a thickness of 0.3 μm, and the first protective layer and the second protective layer were PET films having a thickness of 4 μm.

The first electrode layer (copper-deposited thin film) of the sheet-like material was coated with the coating material for forming a piezoelectric layer, which was prepared in advance, using a slide coater. The coating material was applied so that a film thickness of the coating film after drying was 50 μm.

Next, the material obtained by coating the sheet-like material with the coating material was heated and dried on a hot plate at 120° C. to evaporate DMF. In this manner, a laminate in which the first electrode layer made of copper was provided on the first protective layer made of PET and the piezoelectric layer (polymer-based piezoelectric composite material layer) having a thickness of 50 μm was formed thereon was produced.

The produced piezoelectric layer was subjected to a polarization treatment in the thickness direction.

A sheet-like material obtained by vapor-depositing a copper thin film on the PET film was laminated on the piezoelectric laminate which had been subjected to the polarization treatment such that the second electrode layer (copper thin film side) faced the piezoelectric layer.

Next, the laminate of the piezoelectric laminate and the sheet-like material was subjected to thermal compression bonding at a temperature of 120° C. using a laminator device to adhere the piezoelectric layer and the second electrode layer by bonding, thereby producing a piezoelectric film.

### [Production of Laminated Piezoelectric Element]

The produced piezoelectric film was cut into a rectangular shape having a planar shape of 180 mm×220 mm. The cut piezoelectric film was folded four times in the longitudinal direction to laminate five layers of the piezoelectric film, thereby producing a piezoelectric element. The planar shape of the laminated portion was set to 180 mm×40 mm, and the planar shape of the protruding portion was set to 180 mm×20 mm. The layers of the piezoelectric film laminated were bonded to each other with a bonding layer (acrylic pressure sensitive adhesive). An electrode lead-out portion was formed on the protruding portion protruding from the laminated portion.

Five sheets of such a laminated piezoelectric element were produced.

### <Production of Electroacoustic Transducer>

The produced five laminated piezoelectric elements were bonded to a vibration plate. As the vibration plate, a PET plate having a thickness of 0.5 mm, and a length of 690 mm×a width of 1,210 mm was used. A lateral direction of the vibration plate and a longitudinal direction of the piezoelectric element were aligned, the vibration plate was divided into four equal parts in the lateral direction, and five laminated piezoelectric elements were bonded to the center position of the right end region thereof at intervals in the up-down direction. The interval between the laminated piezoelectric elements (laminated portion) was set to 40 mm. The piezoelectric element and the vibration plate were bonded to each other with a bonding layer (acrylic pressure sensitive adhesive).

A power amplifier (STR-DH190 manufactured by Sony Corporation) was connected as an amplifier to each of the laminated piezoelectric elements of the produced electroacoustic transducer. A sine sweep signal was input to the amplifier for measuring frequency characteristics, and a pink noise signal was input to the amplifier for measuring power consumption.

In addition, an output (volume) of the amplifier in a case where the input signal was input to each laminated piezoelectric element was set to a volume position where the power consumption was a total of 75 W (15 W per one) in a case where the pink noise signal was input to the five vibrators, without performing a low-pass filter processing described later.

In this case, as in the example shown in FIG. 2, five laminated piezoelectric elements were divided into three groups, and the amplifier was connected to each group. The input signal was divided into three signals using a line splitter (LS-01J) of FX-AUDIO Co., Ltd., and then processed by a low-pass filter in which the cutoff frequency was set to the upper limit frequency of each group, and each signal was input to the amplifier. In addition, a cutoff attenuation slope of the low-pass filter was set to 18 dB/oct.

One laminated piezoelectric element was set as a first group, and the upper limit frequency of the input signal input to the laminated piezoelectric element was set to 20 kHz. In addition, another two laminated piezoelectric elements were set as a second group, and the upper limit frequency of the input signal input to the laminated piezoelectric elements was set to 10 kHz. Furthermore, another two laminated piezoelectric elements were set as a third group, and the upper limit frequency of the input signal input to the laminated piezoelectric elements was set to 4 kHz.

### Comparative Example 1

An electroacoustic transducer was produced in the same manner as in Example 1, except that an input signal having an upper limit frequency of 20 kHz was input to all of the five laminated piezoelectric elements.

### Evaluation

A sound pressure in a high sound band and the power consumption of the produced electroacoustic transducers of each of Examples and Comparative Example were evaluated.

The results are shown in FIGS. 3 and 4.

From FIG. 3, it was found that the sound pressure in a high sound band was improved and the power consumption could be significantly reduced in the examples of the present invention as compared with the comparative example.

From the above, the effects of the present invention are clear.

In the above-described embodiment, the configuration is adopted in which the upper limit frequency of the input signal is different for each group, but the present invention is not limited thereto, and a configuration can also be adopted in which the lower limit frequency is different for each group. For example, by making the upper limit frequency different for each group and making the lower limit frequency different, it is possible to slightly decrease the sound pressure in the low sound band, which is likely to be excessive in sound pressure, in addition to improving the sound pressure in the high sound band, and it is also possible to approach the flat frequency characteristic as a whole.

### EXPLANATION OF REFERENCES

10: piezoelectric film
11a, 11c: sheet-like material
11b: piezoelectric laminate
19: bonding layer
20: piezoelectric layer
24: first electrode layer
26: second electrode layer
28: first protective layer
30: second protective layer
34: matrix
36: piezoelectric particle
40, 42: conductive wire
50, 50a to 50l: piezoelectric vibrator
58: core rod
60R, 60L: vibrator group
100, 100b, 100c: electroacoustic transducer
102, 102b: vibration plate
104: bonding layer
120, 120b, 120c: circuit
124G1, 124G2, 124G3: distributor
125G1, 125G2, 125G3: low-pass filter
126, 126G1, 126G2, 126G3, 128: amplifier
127: channel divider
G1: first group
G2: second group
G3: third group
G4: fourth group

What is claimed is:

1. An electroacoustic transducer comprising:
a vibration plate; and
a vibrator group consisting of a plurality of piezoelectric vibrators arranged on one surface of the vibration plate,
wherein the plurality of piezoelectric vibrators each belong to any one of a first group to an n-th group,
an upper limit frequency of a frequency band of an input signal input to the piezoelectric vibrator is different for each group, and
in a case where upper limit frequencies for each group are denoted by f₁ to fₙ, the upper limit frequencies gradually decrease from the upper limit frequency f₁ in the first group to the upper limit frequency fₙ in the n-th group.

2. The electroacoustic transducer according to claim 1,
wherein, in a case where the number of the piezoelectric vibrators belonging to each group is denoted by N₁ to Nₙ, the number of the piezoelectric vibrators in each group from the number N₁ of the piezoelectric vibrators in the first group to the number Nₙ of the piezoelectric vibrators in the n-th group satisfies N₁≤N₂≤N₃≤ . . . ≤Nₙ.

3. The electroacoustic transducer according to claim 1,
wherein the upper limit frequency f₁ in the first group is 15 kHz or more.

4. The electroacoustic transducer according to claim 1,
wherein the electroacoustic transducer has two vibrator groups, and
the two vibrator groups are arranged symmetrically with respect to a center line of the vibration plate in a left-right direction.

5. The electroacoustic transducer according to claim 1,
wherein the piezoelectric vibrator has a piezoelectric film which includes a piezoelectric layer and electrode layers provided on both surfaces of the piezoelectric layer.

6. The electroacoustic transducer according to claim 5,
wherein the piezoelectric layer consists of a polymer-based piezoelectric composite material containing piezoelectric particles in a matrix containing a polymer material.

7. The electroacoustic transducer according to claim 5,
wherein, in the piezoelectric vibrator, a plurality of layers of the piezoelectric film are laminated by folding the piezoelectric film one or more times.

8. The electroacoustic transducer according to claim 1,
wherein outer peripheral edges of two adjacent piezoelectric vibrators are in a parallel relationship, and an interval between the outer peripheral edges is 40 mm or less.

9. The electroacoustic transducer according to claim 1,
wherein the vibration plate is curved in an arrangement direction of the plurality of piezoelectric vibrators of the vibrator group.

10. The electroacoustic transducer according to claim 9,
wherein, in the arrangement direction of the plurality of piezoelectric vibrators, in a case where a distance from the piezoelectric vibrator on a center side of the vibration plate to a viewing position is denoted by L₁ and a distance from the piezoelectric vibrator on an outer side to the viewing position is denoted by L₂, a range of L₁×0.9<L₂<L₁×1.1 is satisfied.

11. The electroacoustic transducer according to claim 1,
wherein, in an arrangement direction of the plurality of piezoelectric vibrators, in a case where a distance from the piezoelectric vibrator on a center side of the vibration plate to a viewing position is denoted by L₁ and a distance from the piezoelectric vibrator on an outer side to the viewing position is denoted by L₂, an input timing of the input signal to the piezoelectric vibrator on the outer side is set to be earlier than an input timing of the input signal to the piezoelectric vibrator on the center side by a time t=(L₂−L₁)/c,
where c (m/s) is a speed of sound.

12. The electroacoustic transducer according to claim 2,
wherein the upper limit frequency f₁ in the first group is 15 kHz or more.

13. The electroacoustic transducer according to claim 2,
wherein the electroacoustic transducer has two vibrator groups, and
the two vibrator groups are arranged symmetrically with respect to a center line of the vibration plate in a left-right direction.

14. The electroacoustic transducer according to claim 2,
wherein the piezoelectric vibrator has a piezoelectric film which includes a piezoelectric layer and electrode layers provided on both surfaces of the piezoelectric layer.

15. The electroacoustic transducer according to claim 14,
wherein the piezoelectric layer consists of a polymer-based piezoelectric composite material containing piezoelectric particles in a matrix containing a polymer material.

16. The electroacoustic transducer according to claim 14,
wherein, in the piezoelectric vibrator, a plurality of layers of the piezoelectric film are laminated by folding the piezoelectric film one or more times.

17. The electroacoustic transducer according to claim 2,
wherein outer peripheral edges of two adjacent piezoelectric vibrators are in a parallel relationship, and an interval between the outer peripheral edges is 40 mm or less.

18. The electroacoustic transducer according to claim 2,
wherein the vibration plate is curved in an arrangement direction of the plurality of piezoelectric vibrators of the vibrator group.

19. The electroacoustic transducer according to claim 18,
wherein, in the arrangement direction of the plurality of piezoelectric vibrators, in a case where a distance from the piezoelectric vibrator on a center side of the vibration plate to a viewing position is denoted by L₁ and a distance from the piezoelectric vibrator on an outer side to the viewing position is denoted by L₂, a range of L₁×0.9<L₂<L₁×1.1 is satisfied.

20. The electroacoustic transducer according to claim 2,
wherein, in an arrangement direction of the plurality of piezoelectric vibrators, in a case where a distance from the piezoelectric vibrator on a center side of the vibration plate to a viewing position is denoted by L₁ and a distance from the piezoelectric vibrator on an outer side to the viewing position is denoted by L₂, an input timing of the input signal to the piezoelectric vibrator on the outer side is set to be earlier than an input timing of the input signal to the piezoelectric vibrator on the center side by a time t=(L₂−L₁)/c,
where c (m/s) is a speed of sound.
